(19) United States
(12) Patent Application Publication
(10) Pub. No.: US 2013/0290195 A1
(43) Pub. Date: Oct. 31, 2013

(54) DETERMINATION OF APPRAISAL ACCURACY

(71) Applicant: LPS IP HOLDING COMPANY, INC., Jacksonville, FL (US)

(72) Inventors: Ronald Lynn Frazier, Villa Park, CA (US); Daniel Brian Sogorka, Encinitas, CA (US); Mark Richard Johnson, Newport Beach, CA (US); Jeffrey Albert Sanderson, Coto De Caza, CA (US); John David Holbrook, Suwanee, GA (US)

(21) Appl. No.: 13/675,195

(22) Filed: Nov. 13, 2012

Related U.S. Application Data
(63) Continuation-in-part of application No. 13/458,893, filed on Apr. 27, 2012.

(51) Int. Cl. G06Q 50/16

(52) U.S. Cl. 705/306

(57) ABSTRACT

A method for determining the accuracy of an appraisal report using a computer implemented application, including pre-validating an appraisal report to determine whether a first set of rules has been satisfied, the appraisal report including N fields to be completed, the first set of rules comprising completion of a pre-determined number of N fields; proceeding to a post-validating step if the first set of rules is satisfied; post-validating an appraisal report to provide an evaluation thereof, the evaluation including a plurality of risk categories including risk level indicators, and a risk-based overall score.

### BACKGROUND OF THE INVENTION

The mortgage-related downturn in the U.S. economy, occurring in the late 2000's, has resulted in a renewed emphasis on accuracy and quality of appraisals to better support responsible lending practices. As lenders and investors seek full faith and confidence before originating mortgage loans, and to effectively manage risk, a pristine appraisal has become an essential component to the origination process. Recently, the government sponsored entities (GSEs) set forth the Uniform Mortgage Data Program (UMDP), calling for sound underwriting practices aimed at improving appraisal quality and reducing risks. Traditionally, manual appraisal reviews have been the primary approach to appraisal quality control; however, manual reviews leave basic elements open to interpretation. As a result, inconsistencies in the appraisal report that may lead to the discovery of a problem might go unnoticed.

While there have been mortgage-related systems described for evaluation of loan risk and calculation of risk during the preparation of loans and systems that apply rules to obtain scores (see, e.g., US 2006/0224499, US 2008/0103963, U.S. Pat. No. 7,212,995, and U.S. Pat. No. 7,599,882, each of which is incorporated in its entirety into this application), there has not been described a comprehensive system for providing a determination of appraisal accuracy. Further, although a rules-based system called GAAR™ (Generally Accepted Appraisal Rules™) is currently available, which is asserted as providing a series of rules by which residential real estate appraisals are screened for completeness, compliance with rules and guidelines set forth by various regulatory bodies, and for signs of fraud, overvaluation and other elements representing risk to a lender, the output thereof consists of only a score, and there is no pre-validation process available. Moreover, the available system does not support individual lender customization.

Accordingly, it would be desirable to provide a system and tool that identify risks in appraisal reports in a streamlined secure manner. Moreover, it would be desirable to provide a two-stage product that includes first, a pre-validation step which focuses on factual errors, and a post-validation step that focuses on judgment errors. Further, it would be desirable to provide a two-stage product that requires passage of the first pre-validation step prior to progressing to the second post-validation step. Further still, it would be desirable to provide categories of validation based on industry standard rules, external data, and customizable lender thresholds, and a scoring protocol to efficiently assist lenders and investors. These and other aspects of a system to determine appraisal accuracy are described herein and appended hereto.

### SUMMARY

Various aspects and embodiments for a system and method for determining appraisal accuracy is described herein. The system to determine appraisal accuracy, in one embodiment, is a scoring tool that identifies risks in real estate appraisal reports. The system reduces time and errors for appraisal reviewers and underwriters by uncovering and flagging complex issues embedded within the appraisal report without any manual processing. The system uses appraisal data, configurable customer thresholds, mortgage and appraisal industry standards and external data sources to validate the appraisal for formatting and completeness. Risk flags and scores are reported in a clear and simple format.

Appraisal reviews can be time consuming for mortgage underwriters and appraisal reviewers. Inconsistencies may be missed because the basic elements within appraisal reports are subject to interpretation and could be misread as typical or within the range of guidelines. The system helps to automate, standardize and simplify the appraisal review process by gathering and processing available data and using configurable rules to process qualified results.

In one embodiment, a lender orders an appraisal from a dedicated service provider through a Collaborative Partner Network (CPN). The CPN operates an electronic collaboration network of information utilized in the inventive appraisal accuracy system. The appraisal service provider completes the appraisal order and sends it back through the CPN for processing by the appraisal accuracy system, which sending automatically triggers a pre-validation report.

Generally, the appraiser will use his software of choice to enter the appraisal data, which data is pushed to the CPN. If the appraisal does not pass the pre-validation step, thereby producing a failing report, the appraisal is sent back to the appraisal service provider, along with the pre-validation report, for revision in the areas identified by the report. After the appraisal passes the pre-validation step (either initially or after one or more revisions), a validation report is generated that, together with the pre-qualified appraisal, is forwarded to the lender.

In one embodiment, the validation report accesses various third-party data sources to evaluate appraisal data across several risk categories. The validation report identifies the subject property's complexity, comparable data and opinion of value by using public records such as mortgage, assessment and deed data. Data sources include, but are not limited to: The Appraisal Subcommittee (for appraisal credentials), public records (for mortgage assessment and deed data), and flood insurance providers. Risk Categories include, but are not limited to: subject property complexity, appraisal credentials, comparable data and opinion of values, and industry guidelines (e.g., Fannie Mae, Freddie Mac, FHA, USPAP, etc.).

In one embodiment, appraisal quality assessment is based upon the volume of issues found within the validation report and the information is delivered using easy to understand risk-based scoring levels. The validation report clearly identifies any appraisal data points that don't meet industry standards, and flags risk level indicators associated with a lender's customized pre-identified thresholds using the color convention Red, Yellow, Green, and Blue. In one embodiment, the color Green indicates a low risk of appraisal rejection, the color Yellow indicates a moderate risk of appraisal rejection (a cursory review of the appraisal is therefore recommended), the color Red indicates a high risk of appraisal rejection (an in-depth review of the appraisal is therefore recommended), and the color Blue indicates that outside data providers were unable to complete data verification (appraisal review recommended).

With respect to the industry standards, in one embodiment, automatic updates would be entered upon revisions going into effect so that any evaluation based on any revised guidelines would be current. Regarding lender customization, parameter values could be selected based on the desires of a particular lender. In one embodiment, the lender could select comparable real estate values to be taken from a five mile radius, while another lender could select a larger radius (e.g., ten miles). The lender customization could be manually entered by a system operator or be directly entered by the lender via web interface. In one embodiment, up to sixty fields are customizable by a lender or other client.

In one embodiment, a set of core rules are applied to the data to confirm key data points using the third-party data sources, and a four factor analysis is performed. First, certain data points are compared to data points in the third-party sources for an audit check of veracity, i.e., whether a stated property sold on a stated date for a stated amount. Second, the appraisals credentials are verified against an appropriate state licensing database to confirm the status of the appraiser as actively licensed and that other qualifications such as experience level specified by the lender are satisfied. Third, the property market characteristics are analyzed to determine the property's complexity, i.e., if the value of the property exceeds a certain threshold or if it is in a floodplain, it may be assigned a higher complexity value. Fourth, the assigned appraisal value is compared to an automated valuation model, which has been calculated by an external database to test whether the assigned value is within an expected tolerance of the automated predicted value. Following this analysis, in one embodiment, the inventive system uses an algorithm to dynamically weigh the complexity of the property and each of the results of the four factor analysis to assign a score and risk factor to the appraisal. In this embodiment, the weighting of the factors can be adjustable. For example, a property with complex characteristics may have a higher tolerance level between appraised value and an automated value such that a higher difference between the values is considered less important relative to the overall score.

With respect to the validation report output, in one embodiment, the report contains a risk assessment level, a score regarding the analysis of the appraisal data and a list of inconsistencies. An overall score and assessment is provided along with a more detailed report for each category of analysis and noted inconsistencies. In one embodiment, an electronic version is transmitted to the lender, which enables clicking of hyperlinks from a summary page to various areas of the report, depending on the areas of interest particular to the lender (where more detail is desired for review).

Lenders may use numeric risk scores within the report to define the appropriate level of appraisal review based on the level of risk identified. Numeric scores are determined from the volume of issues found within the collateral reports and are subsequently categorized into low, moderate or high risk levels.

The report provides numerous advantages to lenders. It saves time and reduces errors for underwriters and appraisal reviewers by identifying areas of potential risks that could be missed manually. It limits buybacks with investors by validating appraisal data against specific investor requirements. Lenders can configure the appraisal workflows with the report and use the latest industry guidelines and standards. It is flexible in supporting the appraisal ordering, correction and completion process. It provides an audit trail and integrates with existing lender and provider systems.

Providers also benefit from the report. The report enables collaboration with lender resources to correct any errors that may be found and reduces potential errors by finding incomplete, missing or erroneous information within the appraisal report. Providers can now react to errors and formatting issues in real time to make changes that previously may have taken days to uncover. This helps providers improve their ability to meet service level agreements with their lender clients.

Today's market environment places increasing importance on data quality and standardization. The report addresses this by providing high value to lenders and appraisers. The report's data-centric design enables validation and assessment of specific data elements across several key evaluation points, including an initial review of each data element within the valuation report for completeness and compliance with industry standards and best practices.

More specifically, based on the published GSE requirements associated with the Uniform Mortgage Data Program (UMDP), the report's data validation capabilities provide lenders with a centralized utility for ensuring valuation products' compliance with required industry data formats now and as they continue to evolve. This capability, combined with the existing company valuation product workflow and valuation provider integrations/relationships, provides a practical means of assisting providers with identifying situations requiring changes within their systems or processes to deliver data in the required standard format.

### BRIEF DESCRIPTION OF THE DRAWINGS

These and other objects, advantages and features of the present invention will be readily appreciated as the same becomes better understood by reference to the following detailed description when considered in connection with the accompanying drawings, in which like reference numerals designate like parts throughout the figures thereof and wherein:

FIG. 1 is a flowchart of a method in one embodiment of the present invention;

FIG. 2 is a flowchart of core rules used in an embodiment of the present invention;

FIG. 3A is an example of a low appraisal risk report cover page in accordance with an embodiment of the present invention;

FIG. 3B is an example of a report header in accordance with an embodiment of the present invention;

FIG. 3C is an example of an overall report score in accordance with an embodiment of the present invention;

FIG. 3D is an example of a subject property complexity in accordance with an embodiment of the present invention;

FIG. 3E is an example of an appraiser's credentials in accordance with an embodiment of the present invention;

FIG. 3F is an example of comparables in accordance with an embodiment of the present invention;

FIG. 3G is an example of threshold rules in accordance with an embodiment of the present invention;

FIG. 4 is an example of a pre-validation failure report in accordance with an embodiment of the present invention;

FIG. 5A is an example of a red high appraisal risk report cover page in accordance with an embodiment of the present invention;

FIG. 5B is an example of a rules violation report in accordance with an embodiment of the present invention;

FIG. 6A is an example of a blue high appraisal risk report cover page in accordance with an embodiment of the present invention; and

FIG. 6B is an example of a rules violation report in accordance with an embodiment of the present invention.

FIG. 7 is a flowchart indicating further detail of one embodiment of the system shown in FIG. 1 and FIG. 2.

FIG. 8 is a flowchart indicating further detail of the system shown in FIG. 1 and FIG. 2 and indicates subsequent processing steps taken by the system of FIG. 7.

FIG. 9 is a flow chart indicating further detail of one embodiment of step 807 in FIG. 8.

FIGS. 10A and 10B are together a flowchart indicating further detail of one embodiment of step 810 in FIG. 8.

FIG. 11-15 are flow charts indicating possible embodiments of rule logic executed in step 805 of FIG. 8.

### DETAILED DESCRIPTION OF THE INVENTION

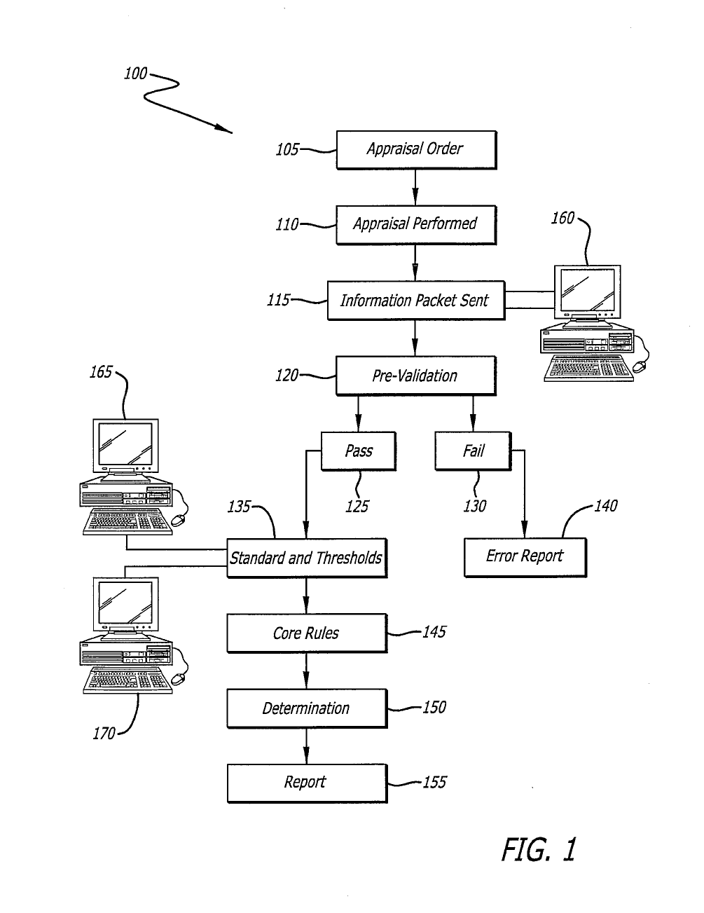

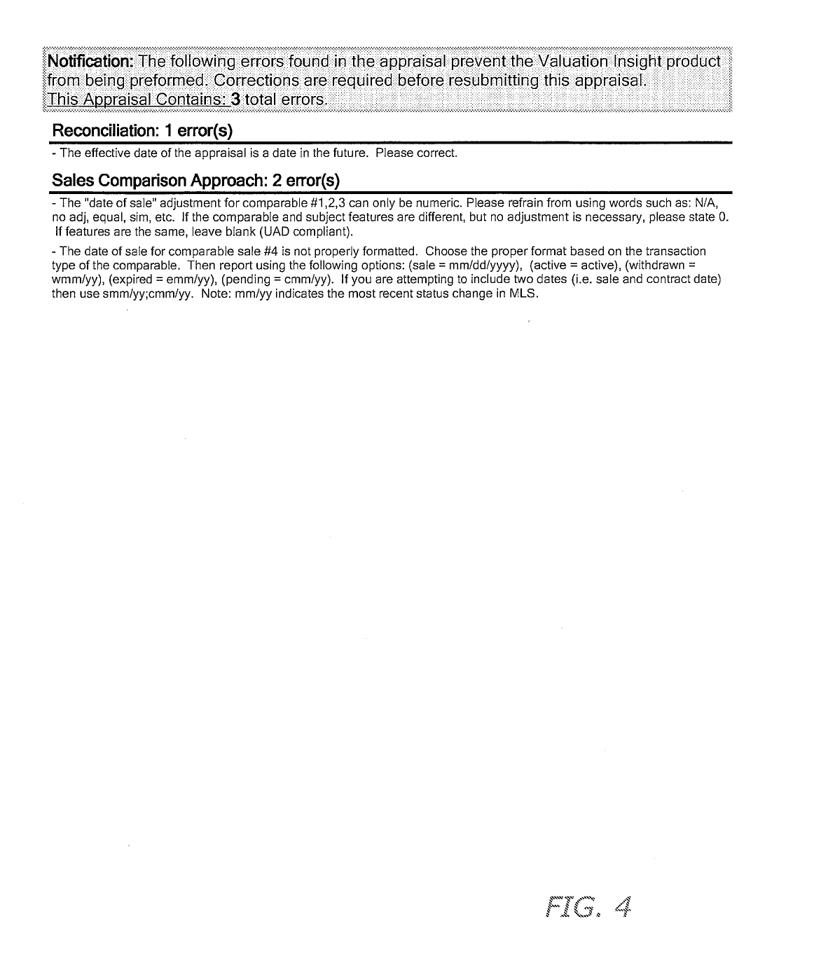

In FIG. 1, method for determining the accuracy of an appraisal report 100 using a computer-implemented application is shown. In the first step 105 of the method, a proposed lender generates an appraisal request to an appraiser or an appraisal management company, which then proceeds to conduct an appraisal 110. Once the appraisal is complete, the appraisal information is transmitted to a processing computer 160 as a packet of information 115. Pre-validation rules 120 are then applied to the packet of information to confirm that the data submitted is complete and normalized, meaning that all required fields have been completed, that the type of data is format compatible and that the data entered is within basic expected parameters. The pre-validation rules 120 validate the appraisal to verify the appraisal was completed and all data needed to complete the full report is present in the appraisal. The pre-validation rules 120 check and notate incomplete, missing, and inconsistent data within the appraisal report. If a violation 130 of the pre-validation rules is found, a pre-validation failure report 140 is generated, which highlights corrections required to the appraisal before the appraisal can be resubmitted for processing. FIG. 4 is an example of a pre-validation failure report. Errors, along with procedures to correct errors, are laid out for an appraiser's attention.

Once the pre-validation rules are satisfied, in the next step 135 the system compares the appraisal data to industry standard validation rules 165 and lender customized thresholds 170. Industry standard validation rules 165 are guidelines on how real estate appraisals should be conducted, for example as published by Fannie Mae or Federal Housing

Administration (FHA) regulations. These may be manually written rules saved to the computer system, or a database of rules pulled from the relevant sources, allowing automatic updates when such guidelines are updated. Lender customized thresholds 170 are parameter values which may be selected by individual lenders to test data in an appraisal. For example, one lender may want comparable real estate values taken from within a five mile radius while another lender may select a ten mile radius. The lender customized thresholds 170 may be input into the system by the system operator, or through a lender interface to be accessed over a remote connection to select, change and save such thresholds. The results of the industry standard validation rules 165 and the customized threshold 170 applications are preferably a list of inconsistencies needing further review. Rule narratives within the report will highlight which specific guidelines have not been met. The rules also include standard rules designed to confirm key data points on the appraisal using external data sources. Discrepancies are highlighted and given a score of low, medium or high based upon client-defined thresholds.

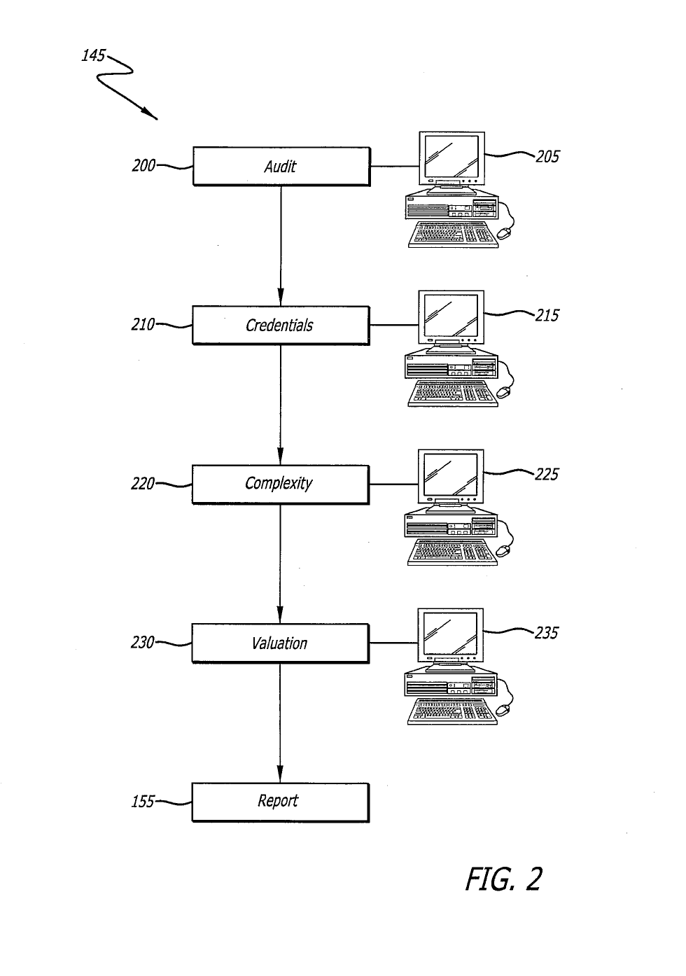

At the next step, a set of core rules 145 are applied to the data to confirm key data points using external data sources. This involves a four factor analysis, detailed in FIG. 2. First, certain data points 200 are compared to data points in external databases 205 purely for an audit check of the truthfulness of the information, for example was a particular property sold on a certain date for a certain amount. Second, the appraiser's credentials 210 are checked against an appropriate state licensing database 215 to confirm the status of the appraiser as actively licensed and that other qualifications such as the experience level specified by the lender are satisfied. Third, the core rules 145 compare the property market characteristics to an external database 225 to determine the complexity 220 of the property. For example, if the value of the property exceeds a certain threshold or if it is in a flood plane it may be deemed as more complex. Fourth, the core rules 145 compare the assigned appraisal value 230 to an automated valuation model, which has been calculated by an external database 235 to test whether the assigned value is within an expected tolerance of the automated predicted value.

Once the four factored analysis of the core rules 145 has been applied, the system uses a determination 150, for example via an algorithm, to dynamically weigh the complexity of the property and the core test results to assign a score and risk factor to the appraisal. Importantly, the weighting given to the different factors can change depending on the results of other factors. For example, a property with complex characteristics may have a higher tolerance level between appraised value and an automated value so a higher difference between the values is considered less important relative to the overall score in that situation.

Upon completion of the analysis, a report 155 is delivered to the lender containing a risk assessment level, a score regarding the analysis of the appraisal data and a list of inconsistencies. Preferably an overall score and assessment is provided as well as a more detailed report with respect to each category of analysis and the noted inconsistencies. The report provides an understanding of the complexity of the appraisal along with an overall score to allow for the correct level of review to occur. If major issues are identified, they are highlighted in a clear and concise manner to enable appropriate follow up actions. In a preferred version, an electronic version may be presented to the lender, allowing the lender to begin with a summary of the report, then click-through or drill down into more detailed information on subjects of interest.

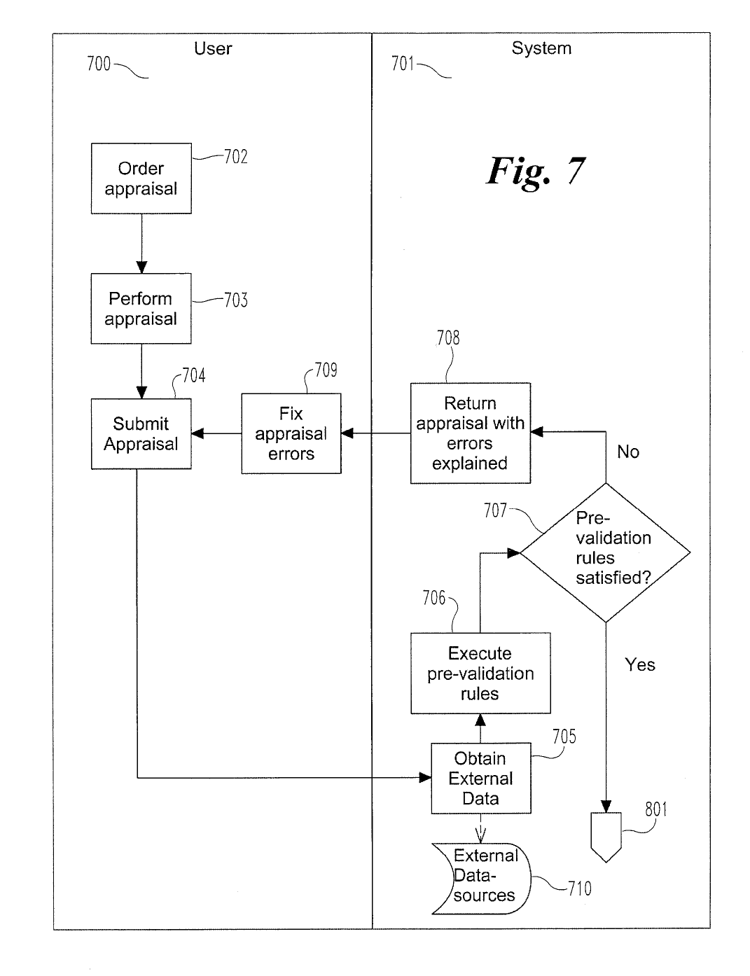

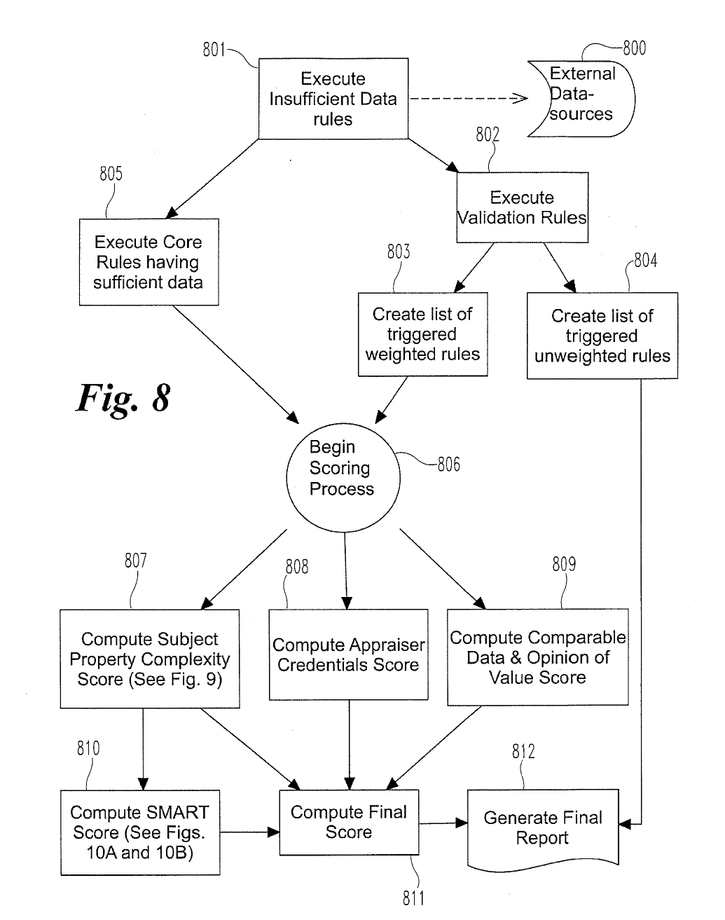

Further details of the appraisal ordering and rule operations within the system are indicated in FIGS. 7 through 15 and described below. FIG. 7 indicates the logical flow of operations performed by the user (left side at 700) and the operations performed by the system (right side at 701) in order to begin the accuracy determination procedure as discussed above. Beginning at 702, an appraisal is ordered, performed (703), and submitted to the system (701) for review. Upon submission, the system obtains external data (705) associated with the appraisal from various external data sources 710. External data sources 710 embodies access to previously discussed external data sources 205, state licensing database 215, external database 225, and external database 235 shown in FIG. 2 and discussed above. Exemplary embodiments of external data sources 710 includes any data sources external to the present system including Automated Valuation Model (AVM) data from vendors such as Lender Processing Services, Jacksonville, Fla., or public records data, including tax assessment, mortgage, and title information as well as information about appraisers from organizations such as the Appraisal Subcommittee (ASC.gov). External data sources also include maps and location data obtainable, for example, from services such as bing.com, and flood related data provided by external systems also available from, for example, vendors such as Lender Processing Services. Data from external sources 710 enters the present system as input useful to aid the system in determining whether, for example, the appraiser's credentials are accurate, or the subject property exists at the address stated. These types of accuracy determinations, and others, can then be made both in the processing of pre-validation rules (706) and in later processing steps as discussed further below in FIG. 8.

Appraisal data, which can also include the data from external sources, is then compared with one or more pre-validation rules (706) to determine if the appraisal has been properly filled out (e.g. proper checkboxes are checked, appropriate fields filled in with valid data, etc.) In the preferred embodiment shown in FIG. 7, the results of these comparisons meet one or more predetermined pre-validation rule conditions before execution of the core and validation rules (see FIG. 8) continues. In one embodiment of these conditions, all pre-validation rules must be satisfied (707) (i.e. the rules are not triggered, “pass”, or pass validation), or the appraisal is delivered back to the submitter (708) along with a report indicating steps the submitter can take to correct the errors. The submitter then adjusts the data as necessary (709) and resubmits the appraisal (704) and the pre-validation process is repeated. The pre-validation process is thus repeated as many times as necessary in order to meet the pre-validation rule conditions.

Various embodiments of the pre-validation rules are envisioned to validate the appraisal information. Table A shows the rule logic for various exemplary pre-validation rules. In Table A, the left column shows a pseudocode description of the logic employed by the rule with field names indicating inputs used by the rule. When the rule is “triggered or “not satisfied”, a narrative or explanation like those shown in the right-hand column is returned back to the submitter. The list below is not exclusive, rather it is exemplary of the kinds of information that may be used to pre-validate the appraisal. Information like the address of the subject property being appraised may be evaluated along with information about the appraiser such as home address, license information, and supervisory appraiser information, as well as information about the type of property, number of rooms, amenities, number of liens, financing irregularities, physical location, comparable property values cited, total gross living area of the subject property, valuation techniques, whether the property is a rental property and information about the number of units rented or not rented, as well as any other information associated with the appraisal of real estate.

TABLE A
EXAMPLE PRE-VALIDATION RULES

| Rule Logic | Conventional Response (Narrative) |
|---|---|
| If <ApprAddr1>, <ApprAddr2>, <ApprAddrCity>, | The appraiser company address is blank. Please |
| <ApprAddrState>, <ApprAddrZip> does not contain a | provide a physical address, refrain from using PO |
| valid address in a combination of any of the fields (PO | Boxes. |
| Box and (#) signs are acceptable), then display the | |
| narrative. | |
| If <ApprCertExpireDate> does not contain a date value, | The appraiser license expiration date is either blank or |
| then display the narrative | is not a recognized format as provided. Please provide |
| | expiration date (for example: Dec. 31, 2010). |
| If <ApprCertNbr> <ApprLicNbr> and | The appraiser license or certification lines are blank. |
| <ApprOtherLicNbr> are all blank, then display the | Please provide license number in Appraisal Sub- |
| narrative | Committee format. |
| If <ApprLicState> does not contain a keyword or is | The field containing the state in which the appraiser is |
| blank, then display the narrative. | licensed is either blank or is not properly formatted. |
| | Please use a 2 character USPS state authorized |
| | abbreviation. |
| If <LenderClientAddr1> and or <LenderClientAddr2> | The lender/client company address is blank. Please |
| or a combination of the two does not contain a complete | provide a physical address for client. |
| address, then display the narrative | |
| If <PropertyApprAddr1>, <PropertyApprAddr2>, | The subject address on the signature page is either |
| <PropertyApprAddrCity>, <PropertyApprAddrState>, | blank or incomplete. Please provide full address of |
| <PropertyApprAddrZip>, <PropertyApprAddrUnit> | subject. |
| does not contain a valid address, then display the | |
| narrative | |
| If <SubjPropertyAppraisedValue> is blank OR contains | The appraised value on the signature page is either |
| a value that is not a numeric value, then display the | blank or does not contain a number. Please provide |
| narrative | the appraised value. |
| If <SuperApprName> contains a value not equal to | On the signature page, the supervisory appraiser |
| keywords, AND both <SuperApprCertNbr> and | license or cerification number, if applicable, cannot be |
| <SuperApprLicNbr> are blank, then display the | blank. |
| narrative | |
| If >= 2 of the 3 following fields | There are fields completed in the cost approach that |
| [<CostApprSiteMktValue>, | would make it appear as if this section was completed. |
| <CostApprAsIsImprValue>, | However, the field “support for the opinion of site |
| <CostApprIndValue>], contain a numeric value > 0 | value” only contains N/A, not available, not applicable |
| AND <CostApprSummaryCompSiteValue> contains | or similar keywords. Please correct this field or |
| ONLY keyword values, then display the narrative | remove numeric values (zero is acceptable) from the |
| | cost approach section if it was not intended to be |
| | completed. |
| If >= 2 of the 3 following fields | There are fields completed in the cost approach that |
| [<CostApprSiteMktValue>, | would make it appear as if this section was completed. |
| <CostApprAsIsImprValue>, | For the fields estimated reproduction and replacement |
| <CostApprIndValue>], contain a numeric value > 0 | cost new, one and only one selection should be |
| AND <CostApprEstReprod> and | chosen. Please correct this field or remove numeric |
| <CostApprEstReplace> both = Yes or both are blank, | values (zero is acceptable) from the cost approach |
| then display the narrative | section if it was not intended to be completed. |
| If both of the fields <CostApprSiteMktValue> and | There are fields completed in the cost approach that |
| <CostApprIndValue> contain a numeric value > 0, | would make it appear as if this section was completed. |
| AND both <CostApprEstReprod> AND | For the fields estimated reproduction and replacement |
| <CostApprEstReplace> =“Yes” or both are blank, else | cost new, only one selection should be chosen. Please |
| display narrative | correct this field or remove numeric values (zero is |
| | acceptable) from the cost approach section if it was |
| | not intended to be completed. |
| If <CostApprExtSubUnitArea2SqFt> DOES NOT = | The square footage in line 2 of the exterior dimensions |
| <CostApprExtDimSubUnit2A> multiplied by | section does not equal the product of the dimensions |
| <CostApprExtDimSubUnit2B>, then display the | shown. Please correct. |
| narrative | |
| (calculations rounded to the nearest whole number) | |
| If <CostApprTotalGLASqFt> DOES NOT = the sum | The total gross living area in the exterior dimensions |
| of (<CostApprExtSubUnitArea1SqFt> + | section does not equal the sum of the square footages |
| <CostApprExtSubUnitArea2SqFt> + | calculated above. Please correct. |
| <CostApprExtSubUnitArea3SqFt> + | |
| <CostApprExtSubUnitArea4SqFt>), then display the | |
| narrative | |
| If <PurposeSale> = yes AND <SellerOwnerDesc> is | For the question “Is the property seller the owner of |
| blank, then display the narrative | record?”, no data source has been provided. If the |
| | assignment type is not a purchase, please choose the |
| | correct assignment type. Otherwise, provide the data |
| | source. |
| If <LoanConcessionsYes>=“yes” and | The appraisal indicates that there is financial |
| <LoanConcessionsAmount> is blank, then 1 of the | assistance to be paid on behalf of the borrower; |
| following must be true: | however, it does not provide the amount. IF the |
| 1. <LoanConcessionsIndicator> = “yes” | appraiser is not able to determine a dollar amount for |
| 2. <LoanConcessionsDesc> contains a numeric value in | all or part of the financial assistance, the number must |
| the node | reflect the total known dollar amount. You can also |
| 3. <LoanConcessionsDesc> contains this comment | leave this field blank if the entire financial assistance |
| “There is a financial assistance amount that is | amount is unknown. If there is any unknown financial |
| unknown” | assistance amount, the appraiser must include this |
| Else, display the narrative. | exact comment in the description field. “There is a |
| | financial assistance amount that is unknown”. Most |
| | software providers will automatically populate this |
| | comment. |
| If <ProjFirstLienBal> contains a numeric value other | The appraiser has indicated that there is or may be a |
| than 0, | First Lien but it has not been adequately described. |
| AND <ProjFirstLienType> is blank, then display the | |
| narrative | |
| If <ProjFirstLienBal> contains a numeric value other | The appraiser has indicated that there is or may be a |
| than 0, | First Lien but has not adequately described the |
| AND <ProjFirstLienRemainTerm> is blank, then | remaining term. |
| display the narrative | |
| If <ProjFirstLienBal> contains a numeric value other | The appraiser has indicated that there is or may be a |
| than 0, | First Lien but has not adequately described the |
| AND <ProjFirstLienMnthlyPmt> is blank, then display | monthly payment. |
| the narrative | |
| If <ProjFirstLienBal> contains a numeric value other | The appraiser has indicated that there is or may be a |
| than 0, | First Lien but has not adequately described the interest |
| AND <ProjFirstLienIntRate> is blank, then display the | rate. |
| narrative | |
| If <ProjFirstLienBal> contains a numeric value other | The appraiser has indicated that there is or may be a |
| than 0, | First Lien but has not adequately indicated if the |
| AND <ProjFirstLienFixed> and <ProjFirstLienARM> | mortgage has a fixed or variable rate. |
| both = Yes, or both are blank, then display the narrative | |
| If <ProjFirstLienBal> contains a numeric value other | The appraiser has indicated that there is or may be a |
| than 0, | First Lien but has not adequately identified the lien |
| AND <ProjFirstLienHolder> is blank, then display the | holder. |
| narrative | |
| If <ProjSecondLienBal> contains a numeric value other | The appraiser has indicated that there is or may be a |
| than 0, | Second Lien but has not adequately identified the First |
| AND <ProjFirstLienBal> does not contain a numeric | Lien. There may not be a Junior Lien without a Senior |
| value, then display the narrative | Lien. |
| If < ProjSecondLienBal > contains an numeric value | The appraiser has indicated that there is or may be a |
| other than 0, | Second Lien but it has not been adequately described. |
| AND < ProjSecondLienType > is blank, then display | |
| the narrative | |
| If <ProjSecondLienBal> contains a numeric value other | The appraiser has indicated that there is or may be a |
| than 0, | Second Lien but has not adequately described the |
| AND <ProjSecondLienRemainTerm> is blank, then | remaining term. |
| display the narrative. | |
| If <ProjOwnerUnits> is blank, then display the narrative | In the project occupancy section, # of units owner |
| | occupied is not described. Please correct. |
| If <SubjRentMnthlyRent> does not contain a numeric | The subject current monthly rent must contain a valid |
| value, then display the narrative | number. |
| If <Fireplace>=“yes”, and <FireplaceNbr> is blank OR | The appraisal is checked that a fireplace exists, |
| does not contain a number greater than 0, then display | however the number of fireplaces has not been |
| the narrative | provided. Please provide the number of fireplaces. If |
| | NO fireplace exists, please uncheck box and provide a |
| | “0” in the field next to the word fireplace. |
| If <PatioDeck> is blank, and <PatioDeckDesc> is blank | If the subject has a patio/deck, please check the box. |
| OR contains text that is not a keyword, then display the | If the subject does not have a patio/deck, please leave |
| narrative | unchecked and provide the word “None” next to the |
| | field. |
| If <Pool> is blank and <PoolDesc> is blank OR | If the subject has a pool, please check the box. If the |
| contains text that is not a keyword, then display the | subject does not have a pool, please leave unchecked |
| narrative | and provide the word “None” next to the field. |
| If <SubjTotalBed> does not contain a numeric value, | The subject above grade room count/bdrms must |
| then display the narrative | contain a numeric value. |
| If <SubjTotalRooms> does not contain a numeric value, | The subject above grade room count/total must |
| then display the narrative | contain a numeric value. |

If the pre-validation rules are satisfied (i.e. not triggered or do not “fail” validation) in step 706, then processing continues with the execution of insufficient data rules at step 801 in FIG. 8. Where the pre-validation rules focused primarily on the submitted appraisal data, the insufficient data rules determine whether information necessary for subsequent core rule processing is unavailable from one or more external data sources 800 relied on by the system. External data sources 800 is similar to external data sources 710 and also embodies data sources 205, 215, 225, and 235 shown in FIG. 2 as discussed above. Processing the insufficient data rules preferably indicates if information from external data sources 800 is missing and identifies which validation and core rules cannot be processed as a result. Indicators are also preferably set to indicate what data was missing or inaccurate so that when, for example, reports like those discussed below are generated, indicators can be displayed showing that some relevant data was unavailable and that therefore some scores could not be calculated. For example, a report might include words, graphical symbols, colors or any combination of thereof, such as a blue symbol or indicator shown in cases where the external data provider was unable to provide data sufficient to verify the submitted appraisal data. Processing the insufficient data rules (801) also includes one embodiment of the audit check discussed above with respect to FIG. 2 where data points 200 are compared to external databases 205 (shown in FIG. 8 at 800).

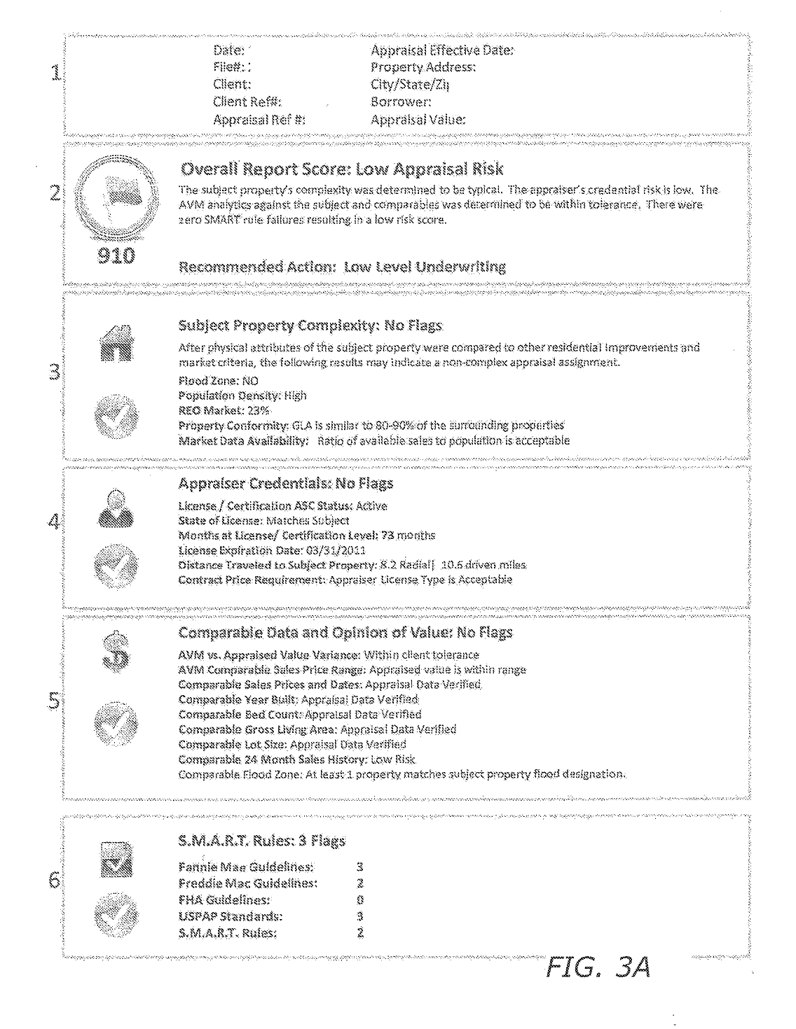

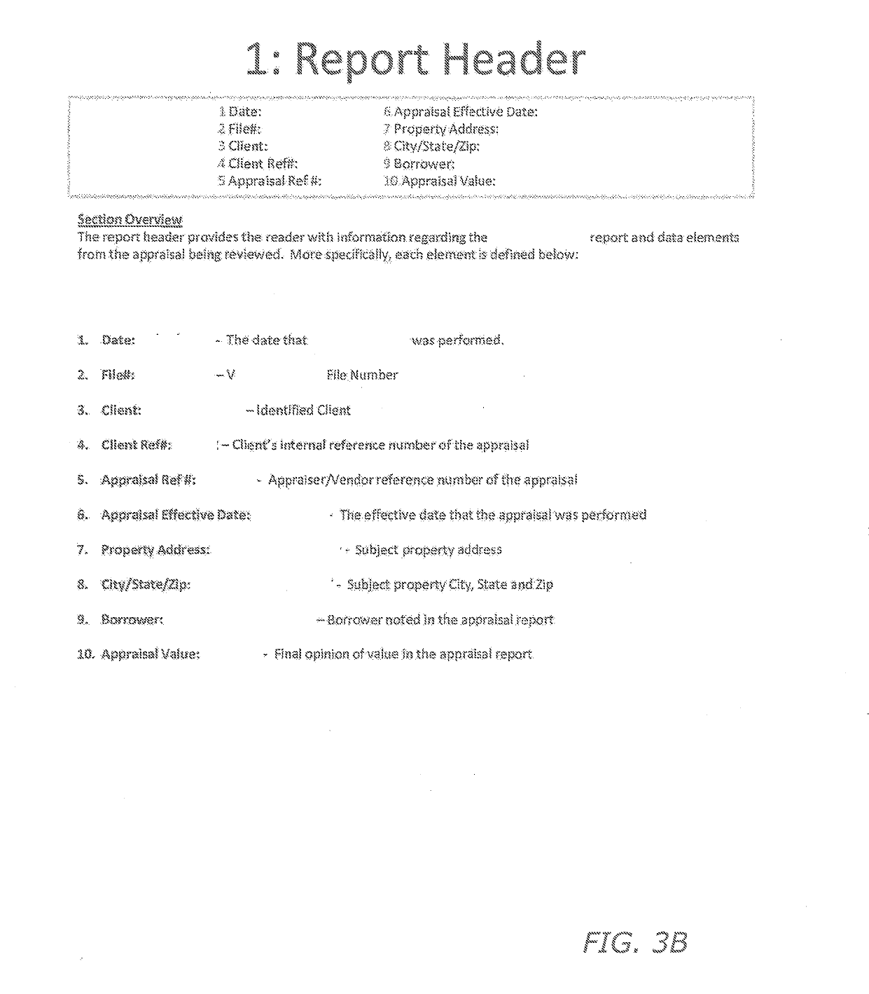

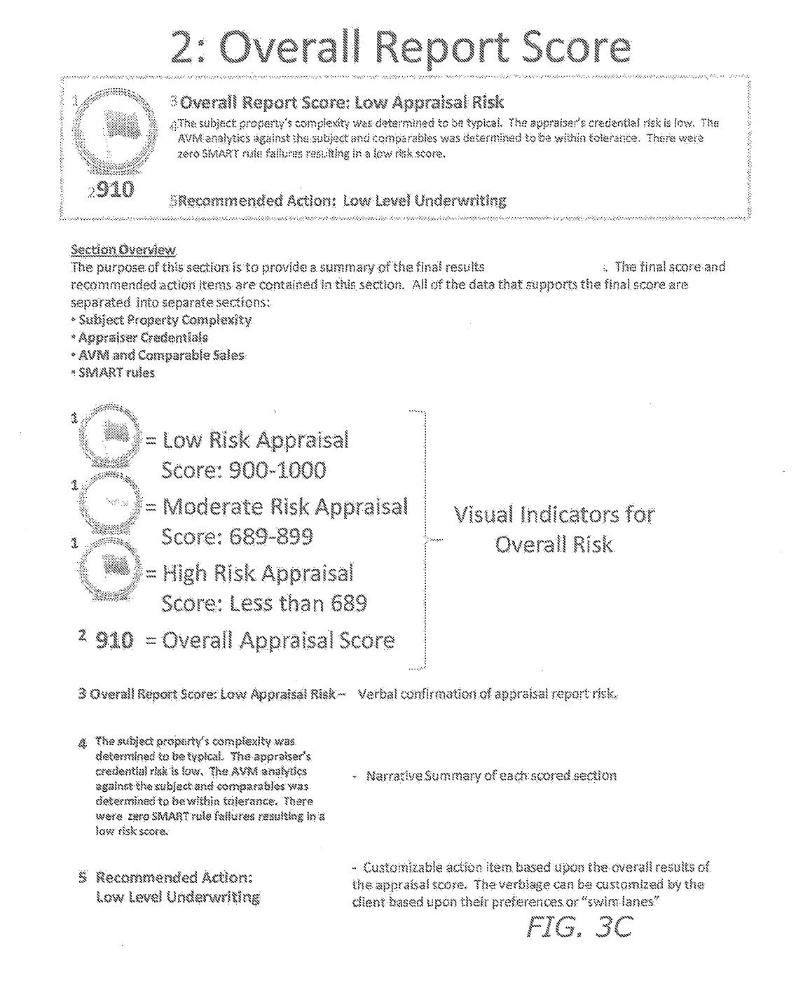

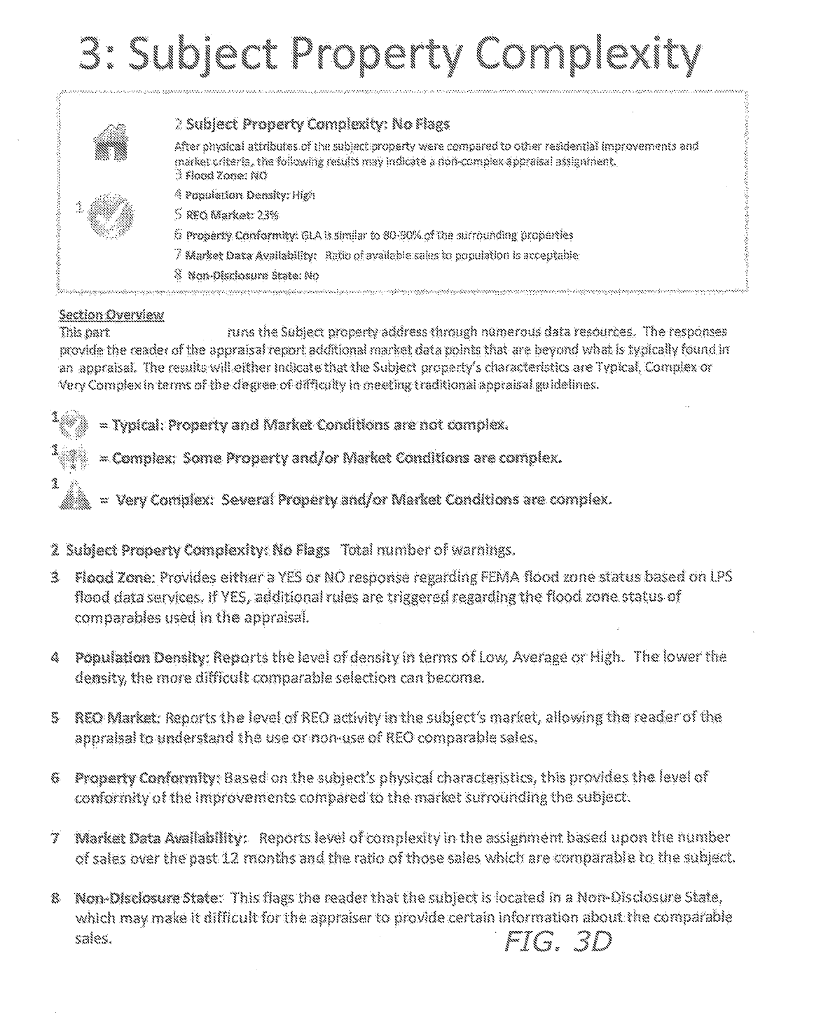

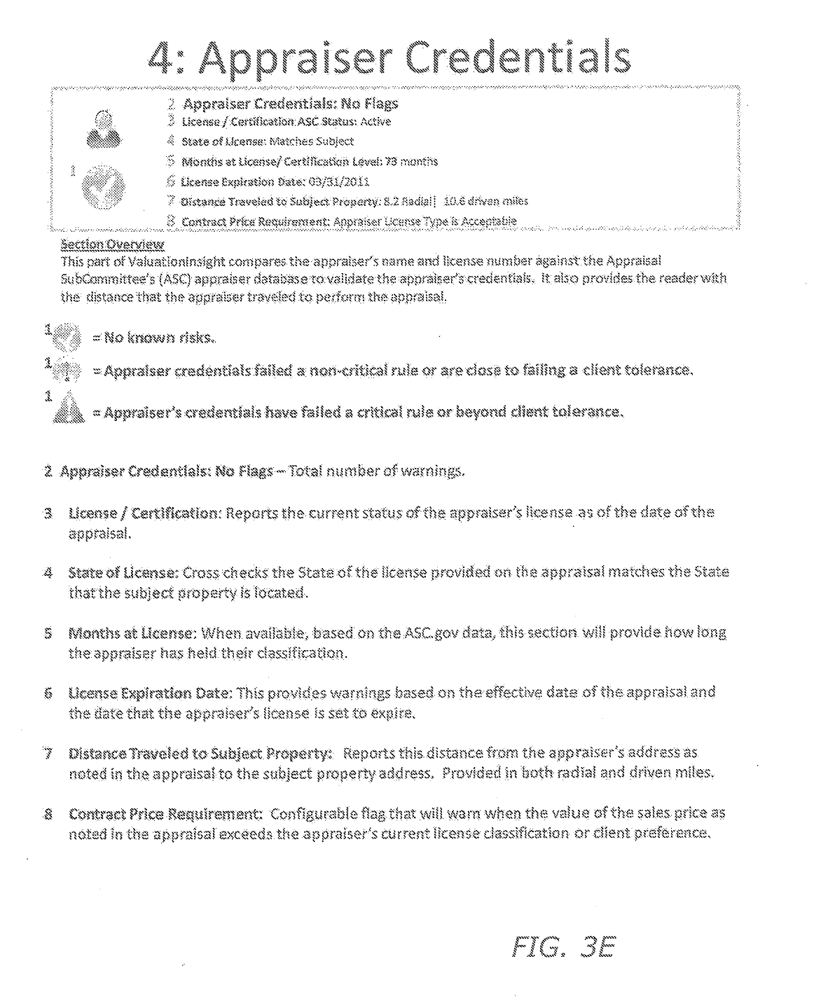

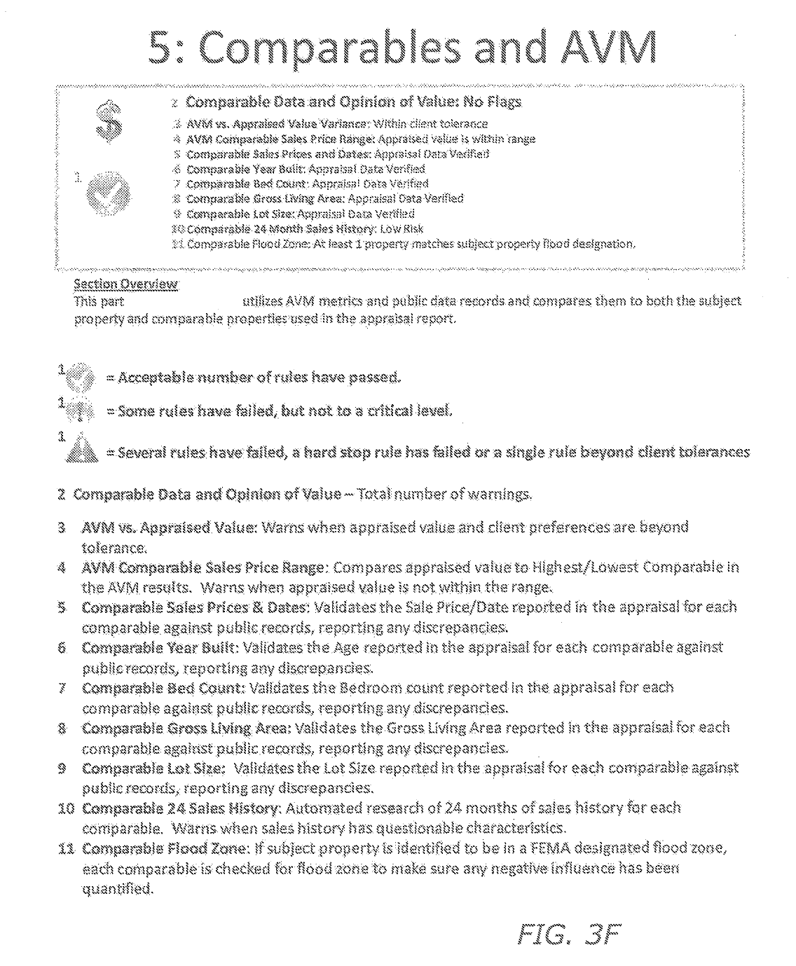

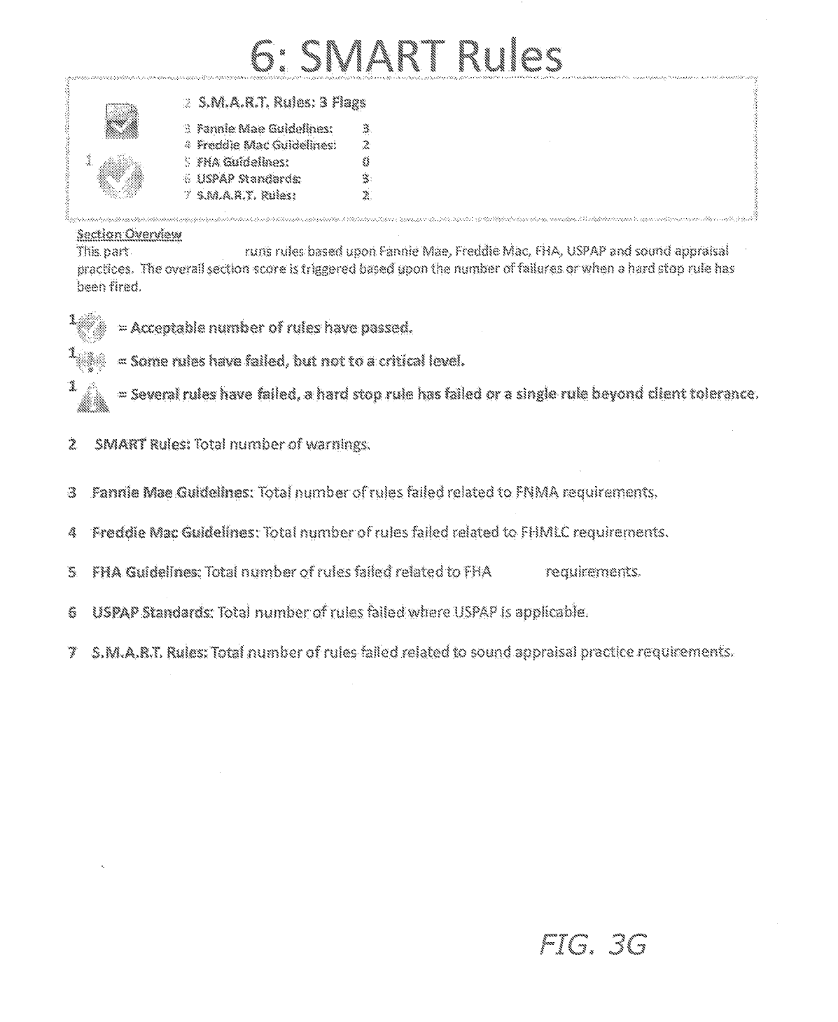

Various embodiments of the pre-validation rules are envisioned to validate the appraisal information. Table B shows the rule logic, description, and narrative associated with some exemplary insufficient data rules. In Table B, rule logic is shown in pseudocode indicating secular fields or sets of fields and expected values or ranges of values required for the rule to be satisfied and not triggered. If the rule is triggered, the “description” field gives some explanation regarding the meaning associated to the failed rule, and the “field level narrative” associated with the rule is an example of what the submitter might be shown when the rule is not satisfied. As with Table A, Table B is an exemplary list not an exclusive list. Other data sources may be used, and the types of data represented here may be adjusted to suite a particular embodiment of the system. Data from any external data source providing data related to the appraisal such as location specific information, tax data, title history, flood, fire, storm, or other historical information, as well as information about properties sold in the area, or information about the appraiser or supervisory appraiser may be considered. External data sources include examples mentioned previously and below with respect to FIGS. 3-6 and may include public sources such as state, local, or federal government databases, information provided from lenders such as banks or mortgage brokers and the like, or from other freely available sources provided by private individuals or companies such as mapping services, title search services, and others.

TABLE B
EXAMPLE INSUFFICIENT DATA RULES

| Rule Logic | Description | Field Level Narrative |
|---|---|---|
| If <MatchStatus> = “I” | If DEX returns MatchStatus = “I” for the | Data sources could not find a |
| (For Subject Property) | Subject Property, this means the address | property matching the address |
| | for the subject property is invalid. | provided in the original |
| | The SubjectPropertyComplexity Core | appraisal |
| | rules will be skipped | |
| If <MatchStatus> = “I” | If DEX returns MatchStatus = “I” for >25% | Data sources could not find a |
| (For >25% of “sold” comparable | of “sold” Comparable Sales, this | property matching the address |
| sales) | means the address for these comparable | provided in the original |
| | properties are invalid | appraisal |
| If <MatchStatus> = “V” | If DEX returns MatchStatus = “V” for the | The address was confirmed as |
| (For Subject Property) | Subject Property, this means the address | valid by data sources, however |
| | for the subject property was valid but a | there is not sufficient data |
| | match was not found. | available to score the section. |
| | | This may have occured for the |
| | | following reasons: |
| | | Subject property is less than |
| | | two years old and physical data |
| | | has not yet been recorded with |
| | | County |
| If <MatchStatus> = “V” | If DEX returns MatchStatus = “V” for >25% | The address was confirmed as |
| (For >25% of “sold” comparable | of “sold” Comparable Sales, this | valid by data sources, however |
| sales) | means the address for these comparable | there is not sufficient data |
| | properties are invalid | available to score the section. |
| | | This may have occured for the |
| | | following reasons: |
| | | Subject property is less than |
| | | two years old and physical data |
| | | has not yet been recorded with |
| | | County |
| If <MatchStatus> = “C” | If DEX returns MatchStatus = “C” for the | The address was confirmed as |
| (For Subject Property) | Subject Property, this means the address | valid by data sources. |
| | for the subject property is in a no | However, at this time the |
| | coverage area. | record lacks sufficient |
| | | information necessary to score |
| | | this section. |
| If <MatchStatus> = “C” | If DEX returns MatchStatus = “C” for > | The address was confirmed as |
| (For >25% of “sold” comparable | 25% of “sold” Comparable Sales, this | valid by data sources. |
| sales) | means the address for these comparable | However, at this time the |
| | properties are invalid | record lacks sufficient |
| | | information necessary to score |
| | | this section. |
| If <MatchStatus> = “M” | If DEX returns MatchStatus = “M” for | Data sources could not find a |
| (For Subject Property) | the Subject Property, this means the | property matching the address |
| | address for the subject property returned | provided in the original |
| | multiple matches | appraisal |
| If <MatchStatus> = “M” | If DEX returns MatchStatus = “M” for > | A unique address match could |
| (For >25% of “sold” comparable | 25% of “sold” Comparable Sales, this | not be found for 2 or more of |
| sales) | means the address for these comparable | the comparable properties. |
| | properties are invalid | There is insufficient |
| | | information to score this |
| | | section. |
| If <MatchStatus> = “ER” | If DEX returns MatchStatus = “ER” for | Data sources could not find a |
| (For Subject Property) | the Subject Property, resulted in an error. | property matching the address |
| | The SubjectPropertyComplexity Core | provided in the original |
| | rules will be skipped | appraisal |
| If <MatchStatus>=“A” AND | If DEX returns a MatchStatus = “A” and | Verification unavailable |
| <REOPercentage> is blank AND | REOPercentage is blank, the following | |
| <ConformityScore> is NOT | rule cannot be executed | |
| blank | | |
| If <MatchStatus>=“A” AND | If DEX returns a MatchStatus = “A” and | Verification unavailable |
| <ConformityScore> is blank | ConformityScore is blank, the following | |
| AND <REOPercentage> is NOT | rule cannot be executed | |
| blank | | |
| If <MatchStatus> =“A” and | If DEX returns a MatchStatus = “A” and | Verification unavailable |
| BOTH <REOPercentage> and | both REOPercentage and | |
| <ConformityScore> are blank | ConformityScore are blank, the following | |
| | rules cannot be executed. | |
| If <MatchStatus>=“A” AND any | If DEX returns a MatchStatus = “A” and | Verification unavailable |
| of the following is blank: | any of these nodes are blank, the | |
| <NbhdNumSalesCurrent>, | following rule cannot be executed | |
| <NbhdNumSalesPriorQtr>, | | |
| <NbhdNumSalesTwoPriorQtr>, | | |
| <NhbdNumSimilarSales> | | |
| If <MatchStatus> = “A” AND | If DEX returns a MatchStatus = “A” and | Verification unavailable |
| <AVMValue> is blank | AVM Value is blank, the following rule | |
| | cannot be executed | |
| If <MatchStatus>= “A” AND | If DEX returns a MatchStatus = “A” and | Verification unavailable |
| <AVMValueHigh> is blank, OR | either AVMValueHigh or | |
| <AVMValueLow> is blank | AVMValueLow are blank, the following | |
| | rule cannot be executed | |
| If <MatchStatus>= “A” AND | If DEX returns a MatchStatus=“A” and | Verification unavailable |
| <LastSaleDate> is blank or 0, OR | either LastSaleDate, or LastSalePrice are | |
| <LastSalePrice> is blank or 0 for | blank or 0 for >25% of the comparable | |
| >25% of “sold” comparable sales) | sales, the following rules cannot be | |
| | executed | |
| If <MatchStatus>=“A” and | If DEX returns a MatchStatus=“A” and | Verification unavailable |
| <YearBuilt> is blank | YearBuilt is blank, the following rule | |
| | cannot be executed | |
| If <MatchStatus>=“A” and | If Bedrooms is blank, the following rule | Verification unavailable |
| <Bedrooms> is blank or zero | cannot be executed | |
| If <MatchStatus>= “A” and | If RoomAboveGrdGLASqFt is blank, the | Verification unavailable |
| <RoomAboveGrdGLASqFt> is | following rule cannot be executed | |
| blank or zero | | |
| If <MatchStatus>=“A” and | If MatchStatus is A and LotSize is blank | Verification unavailable |
| <LotSize> is blank or zero | for the Subject property, the following | |
| | rule cannot be executed | |
| If <MatchStatus>=“A” and | If MatStatus=“A” and Lot Size is blank | Verification unavailable |
| <LotSize> is blank or zero | for the Comparable Sale, the following | |
| | rule cannot be executed | |
| If ASC returns data for the | If ASC retuns data for the Appraiser and | Verification unavailable |
| Appraiser request, AND <Status> | the Status is not listed, the following rule | |
| is blank | cannot be executed | |
| If ASC returns data for the | If ASC retuns data for the Supervisory | Verification unavailable |
| Supervisory Appraiser request, | Appraiser and the Status is not listed, the | |
| AND <Status> is blank | following rule cannot be executed | |
| If ASC returns data for the | If ASC retuns data for the Appraiser and | Verification unavailable |
| Appraiser request, AND | the state abreviation is not listed, the | |
| <st_abbr> is blank | following rule cannot be executed | |
| If ASC returns data for the | If ASC retuns data for the Supervisory | Verification unavailable |
| Supervisory Appraiser request, | Appraiser and the State abreviation is not | |
| AND <st_abbr> is blank | listed, the following rule cannot be | |
| | executed | |
| If ASC returns data for the | If ASC retuns data for the Appraiser and | Verification unavailable |
| Appraiser request, AND | either the effective date, or licence type is | |
| <eff_date> is blank OR | not listed, the following rule cannot be | |
| <lic_type> is blank | executed | |
| If ASC returns data for the | If ASC retuns data for the Supervisory | Verification unavailable |
| Supervisory Appraiser request, | Appraiser and either the effective date, or | |
| AND <eff_date> is blank OR | licence type is not listed, the following | |
| <lic_type> is blank | rule cannot be executed | |
| If ASC returns data for the | If ASC retuns data for the Appraiser and | Verification unavailable |
| Appraiser request, AND | the licence expiriation date is not listed, | |
| <exp_date> is blank | the following rule cannot be executed | |
| If ASC returns data for the | If ASC retuns data for the Supervisory | Verification unavailable |
| Supervisory Appraiser request, | Appraiser and the licence expiriation date | |
| AND <exp_date> is blank | is not listed, the following rule cannot be | |
| | executed | |
| If <FloodCheckStatus>=“U” for | If Flood data returns a “U” for the subject | Unable to determine flood zone |
| the Subject Property | property the following rule cannot be | for this property |
| | executed | |
| If <FloodCheckStatus>=“U” for | If Flood data returns a “U” for >50% of | Comparable #[comparable #] |
| >50% of “sold” comparable sales | “sold” comparable properties the | Unable to determine flood zone |
| | following rule cannot be executed | for this property |
| If <DrivenMiles> does not | If there is no number returned by bing for | Unable to uniquely identify |
| contain a number | driven miles, the following rule cannot be | subject property, rule did not |
| | exectued. | run. |
| If <RadialMiles> does not contain | If there is no number returned by bing for | Unable to uniquely identify |
| a number | radial miles, the following rule cannot be | subject property, rule did not |
| | exectued. | run. |
| If any of the following: | If any of those appraddr fields contain the | Unable to identify appraisers |
| <ApprAddr1>, <ApprAddr2>, | words “PO Box”, the following rule | address (PO Box), rule did not |
| <ApprAddrCity>, | neesd to be skipped | run. |
| <ApprAddrState>, | | |
| <ApprAddrZip> contain the | | |
| words “PO Box” | | |

After the data in the appraisal and the available data sources are compared with the insufficient data rules at 801, the core rules are evaluated (805) and the validation rules (802). The core and validation rules are preferably executed in parallel to save execution time although in some operating environments it may be preferable for steps 805 and 802 to execute one after the other so that one set of rules is processed before the next set is evaluated. FIG. 8 shows the preferred embodiment with a fork in the execution path after the insufficient data rules have completed processing (801), indicating that the validation rules and the core rules can both be processed asynchronously. This is possible because in the preferred embodiment, the core rules do not depend on the results of the validation rules to execute and therefore they may be executed without waiting for validation rule processing to finish. Likewise, in the preferred embodiment, validation rules do not depend on the output of the core rules allowing them to be evaluated regardless of whether the core rules have been executed. However, other embodiments are envisioned where dependencies may exist between the core and validation rules requiring one or the other of them to execute first.

Considering first the core rules, in the preferred embodiment, as discussed briefly above and mentioned below with respect to FIGS. 3-6, certain core rules evaluate submitted appraisal data, and may also use data from external sources 800 in the evaluation. In this embodiment, the core rules are segmented into three main areas and the scores are tabulated later accordingly based on subject property complexity, appraiser info, and comparable property data. Other categories are also envisioned as well and may also be included in the core rules. Preferably the output of a core rule includes a “low” or “high” rating, or in some cases, a “low”, “moderate”, or “high” rating, as well as a numerical score associated with the rating, and a narrative describing or explaining the rating. These ratings can then be used for various purposes such as input into later rule processing logic, or to facilitate the presentation of various embodiments of graphical rating or ranking indicators in the reports discussed in greater detail below. For example, colors, symbols, words, or any combination thereof may be used to indicate the risk level, or level of concern with respect to a particular rule result, or group of rule results. Indicia such as “Green” symbols or words may be used to indicate a low risk or lack of significant issues, “Yellow” indicia for moderate risk, and “Red” indicia for high risk or issues of serious concern. Table C includes descriptions of a number of exemplary core rules indicating various data sources, ranges, types of logic, narratives and associated scores. Various external data sets are used in conjunction with the submitted appraisal data (sometimes referred to below as “387 data”) such as value of the property, information about the appraiser, information about comparable sales near the subject property, flood zone information, and the like. In preferred embodiment of the system, new rules can be added, or existing rules removed or deactivated as needed.

TABLE C
EXAMPLE CORE RULES

| Rule | Rating | Logic | Narrative | Score |
|---|---|---|---|---|
| Determine appraiser's status | Low | If <Status>=“A” | Active | 0 |
| from ASC.gov using the | High | If <Status> <> “A” | Inactive | 300 |
| effective date of the | | | | |
| appraisal | | | | |
| Determine whether | Low | If <State> matches <St_Abbr> | Matches subject | 0 |
| appraiser is licensed in the | High | If <State> does not match | Appraiser's license in | 300 |
| state of the subject property | | <St_Abbr> | <St_Abbr> and | |
| | | | subject property | |
| | | | located in <State>. | |
| Validate the appraisers | Low | If <SalesAmount> is <= | Appraiser's licence | 0 |
| licence type is “state | | 1,000,000 OR If | type is adequate | |
| certified” if the appraisal is | | <SalesAmount> is greater than | | |
| valued at $1 million or | | 1,000,000, AND <lic_type>=“2” | | |
| greater. | | or “3” for either appraiser or | | |
| | | supervisory appraiser | | |
| | High | If <SalesAmount> is great than | Sales contract price is | 100 |
| | | 1,000,000, AND <lic_type> | $1,000,000 or greater | |
| | | does not equal “2” or “3” for | and appraiser's | |
| | | either appraiser or supervisory | license type is not | |
| | | appraiser. | “state certified” | |
| Calculate variange % | Low | If variance between | Variance is witihin | 0 |
| between <AppraisedValue> | | <AppraisedValue> and | client tolerance | |
| and <AVMValue>. Use | | <AVMValue> is <=(10)%, then | | |
| percentage to populate flag | | display low flag message | | |
| and flag message | Moderate | If variance between | Variance between | 100 |
| | | <AppraisedValue> and | appraisal and AVM | |
| | | <AVMValue> is >(10)% and | value slightly | |
| | | <(20)%, then display medium | exceeds client | |
| | | flag message | preferred tolerance | |
| | High | If variance between | Variance between | 200 |
| | | <AppraisedValue> and | appraisal and AVM | |
| | | <AVMValue> is >=(20)%, then | exceeds client | |
| | | display high flag message | tolerance | |
| The appraised value must | Low | If <AppraisedValue> is less than | Appraised value is | 0 |
| be within the range of the | | <AVMValueHigh> and greater | within range | |
| AVM comparable sales of | | than <AVMValueLow> | | |
| low and high | High | If <AppraisedValue> is greater | Appraised value is | 100 |
| | | than <AVMValueHigh> or less | outside of high/low | |
| | | than <AVMValueLow> | AVM range | |
| Define the age of the sale | Low | If the difference in days between | No dated sales noted | 0 |
| for each comparable listed | | the <ApprEffectDate> and | | |
| in the appraisal | | <CompDatePriorSalesTrans> | | |
| Determine difference in | | for ALL comparables is < (90) | | |
| days between | Moderate | If the difference in days between | Comparable(s)[#] | 50 |
| ApprEffectDate and each | | the <ApprEffectDate> and | is/are dated by more | |
| CompDatePriorSalesTrans | | <CompDatePriorSalesTrans> | than [client tolerance] | |
| | | for ANY comparable is >=(90) | days. | |
| | | AND <=(365), while the | | |
| | | difference in days for NO | | |
| | | comparable is <(365) | | |
| | High | If the difference in days between | Comparable(s)[#] | 100 |
| | | the <ApprEffectDate> and | is/are dated by more | |
| | | <CompDatePriorSalesTrans> | than [client tolerance] | |
| | | for ANY comparable is >(365) | days. | |
| First convert <YearBuilt> | Low | If all comps as reported in 387 | Appraisal data | 0 |
| for each comp into an age | | are <(3) year difference from | verified | |
| by subtracting from the | | comps as reported in DEX | | |
| year contained in | Moderate | If any comp as reported in 387 is | Comparable #[#] age | 25 |
| <ApprEffectDate>. | | >=(3) year difference while <(5) | mismatch: appraisal | |
| Determine the difference | | year difference from comp as | reports <AgeYrs>; | |
| between the comparables | | reported in DEX, AND No | verification reports | |
| age from the 387 data and | | comp is >=(5) year difference | <YearBuilt> | |
| the comparables age from | | from comp as reported in DEX | | |
| DEX. | High | If any comp as reported in the | Comparable #[#] age | 50 |
| | | 387 is >=(5) year difference | mismatch: appraisal | |
| | | from comp as reported in DEX | reports <AgeYrs>; | |
| | | | verification reports | |
| | | | <YearBuilt> | |
| Determine the difference | Low | If all comps are <=(0) bed | Appraisal data | 0 |
| between the comparables | | difference | verified | |
| total bed count from the | Moderate | If any comp is >=(1) bed | Comparable #[#] | 25 |
| 387 data and the | | difference while <(2) bed | bedroom mismatch: | |
| comparables total bedcount | | difference, AND No comp is | appraisal reports | |
| from DEX. | | >=(2) bed difference | <TotalBed>; | |
| | | | verification reports | |
| | | | <Bedrooms> | |
| | High | If any comp is >=(2) bed | Comparable #[#] | 50 |
| | | difference | bedroom mismatch: | |
| | | | appraisal reports | |
| | | | <TotalBed>; | |
| | | | verification reports | |
| | | | <Bedrooms> | |
| Determine the difference | Low | If all comps are <(5)% | Appraisal data | 0 |
| between the comparables | | difference | verified | |
| Gross Living Area from the | Moderate | If any comp is >=(5)% while | Comparable #[#] | 25 |
| 387 data and the | | <(10)% difference, AND No | GLA sq. ft. | |
| comparables Gross Living | | comp is >=(10)% difference | mismatch: appraisal | |
| Area from DEX. | | | reports <GLASqFt>; | |
| | | | verification reports | |
| | | | <BuildingArea> | |
| | High | If any comp is >=(10)% | Comparable #[#] | 50 |
| | | difference | GLA sq. ft. | |
| | | | mismatch: appraisal | |
| | | | reports <GLASqFt>; | |
| | | | verification reports | |
| | | | <BuildingArea> | |
| Determine the difference | Low | If all comps are <(5)% | Appraisal data | 0 |
| between the comparable's | | difference | verified | |
| Lot Size from the 387 data | Moderate | If any comp is >=(5)% while | Comparable #[#] lot | 50 |
| and the comparable's Lot | | <(10)% difference, AND No | size mismatch: | |
| Size from DEX. | | comp is >=(10)% difference | appraisal reports | |
| (First make sure all values | | | <Site>; verification | |
| are in the same format) | | | reports <LotSize> | |
| If <Site> or any <SubjSite> | High | If any comp is >=(10)% | Comparable #[#] lot | 100 |
| is >500, please divide by | | difference | size mismatch: | |
| 43560 to convert to | | | appraisal reports | |
| acreage, then run the rule. | | | <Site>; verification | |
| | | | reports <LotSize> | |
| Identify which of the | Low | Subject property IS in a flood | At least 1 propery | 0 |
| comparables, if any used | | zone and => (1) comparable | matches subject | |
| are in a flood zone. Identify | | property in a flood zone | property flood | |
| the comparables by number | | | designation | |
| using their position on the | High | Subject property IS in a flood | No comparable | 50 |
| appraisal report. | | zone and (0) comparable | properties are in a | |
| | | properties are in a flood zone | flood zone | |
| show the appropriate flag | Low | If all comps are <(20)% | Within client | 0 |
| based on the tolerance | | difference | tolerance | |
| level. | Moderate | If any comp is >=(20)% while | Comp #[#]: | 25 |
| | | <(25)% difference, AND No | <SalesPrice> | |
| | | comp is>=(25)% difference | | |
| | High | If any comp is >=(25)% | Comp #[#]: | 50 |
| | | difference | <SalesPrice> | |
| Determine the difference | Low | If all comps are <(10) year | Within tolerance. | 0 |
| between the comparables | | difference | | |
| (age/year built) from the | Moderate | If any comp is >=(10) while | Subject: | 25 |
| 387 data and the Subject's | | <(15) year differece, AND No | [<SubjAgeYrs>]; | |
| (age/year built) from 387. | | comp is >=(15) year difference | Comp # [#]: | |
| | | | [<AgeYrs>] | |
| | High | If any comp is >=(15) year | Subject: | 50 |
| | | difference | [<SubjAgeYrs>]; | |
| | | also show any comps that flaged | Comp # [#]: | |
| | | moderate risk | [<AgeYrs>] | |
| Determine the difference | Low | If all comps are <=(1) bed count | Within tolerance. | 0 |
| between the comparables | | difference from subject | | |
| (total bed count) from the | Moderate | If any comp is >=(2) while <(3) | Subject: | 25 |
| 387 data and the Subject's | | bed count difference, AND No | [<SubjTotalBed>]; | |
| (Total Bed count) from | | comp is >= (3) bed count | Comp # [#]: | |
| 387. | | difference | [<TotalBed>] | |
| | High | If any comp is >=(3) bed count | Subject: | 50 |
| | | difference | [<SubjTotalBed>]; | |
| | | | Comp # [#]: | |
| | | | [<TotalBed>] | |
| Determine the difference | Low | If all comps are <(10)% | Within tolerance. | 0 |
| between the comparables | | difference | | |
| (GLA) from the 387 data | Moderate | If any comp is >=(10)% while | Subject: | 25 |
| and the Subject's (GLA) | | <(15)% difference, AND No | [<SubjGLASqFt>]; | |
| from 387. | | comp is>=(15)% difference | Comp # [#]: | |
| | | | [<GLASqFt>] | |
| | High | If any comp is >=(15)% | Subject: | 50 |
| | | difference | [<SubjGLASqFt>]; | |
| | | also show any comps that flaged | Comp # [#]: | |
| | | moderate risk | [<GLASqFt>] | |
| Identify the risk level based | Low | If <NbhdType> contains any of | Urban | 0 |
| upon the population density | | the low range keywords | | |
| thresholds received | Moderate | If <NbhdType> contains any of | Suburban | 0 |
| | | the mod range keywords | | |
| | High | If <NbhdType> contains any of | Rural | 20 |
| | | the high range keywords | | |
| Identify the risk level of the | Low | If <REOPercentage> is < (10)% | Average for zip code: | 0 |
| subject property based upon | | | <REOPercentage> | |
| the level of REO currently | Moderate | If <REOPercentage> is => | Average for zip code: | 10 |
| present in the market where | | (10)% AND < (20)% | <REOPercentage> | |
| the subject property resides. | High | If <REOPercentage> is => | Average for zip code: | 20 |
| | | (20)% | <REOPercentage> | |
| Identify the risk level based | Low | If <ConformityScore> is => | Property | 0 |
| on the GLA % conformity | | (85%) | characteristics are | |
| score. | | | homogeneous to its | |
| | | | market | |
| | Moderate | If <ConformityScore> is | Property | 10 |
| | | <(85%) while >=(70%) | characteristics are | |
| | | | considered somewhat | |
| | | | homogeneous to its | |
| | | | market | |
| | High | If <ConformityScore> is < | Property | 20 |
| | | (70%) | characteristics are not | |
| | | | homogeneous to its | |
| | | | market | |
| Identify the risk based on | Low | If | Ratio of available | 0 |
| the calculated percentage | | Sum(<NbhdNumSalesCurrent>, | sales to population is | |
| | | <NbhdNumSalesPriorQtr>, | acceptable | |
| | | <NbhdNumSalesTwoPriorQtr>) | | |
| | | /<NbhdNumSimilarSales> is | | |
| | | >=[66%] | | |
| | Moderate | If | Ratio of available | 10 |
| | | Sum(<NbhdNumSalesCurrent>, | sales to population is | |
| | | <NbhdNumSalesPriorQtr>, | not optimal | |
| | | <NbhdNumSalesTwoPriorQtr>) | | |
| | | /<NbhdNumSimilarSales> is => | | |
| | | [34%] and < [66%] | | |
| | High | If | Ratio of available | 20 |
| | | Sum(<NbhdNumSalesCurrent>, | sales is unacceptable | |
| | | <NbhdNumSalesPriorQtr>, | | |
| | | <NbhdNumSalesTwoPriorQtr>) | | |
| | | /<NbhdNumSimilarSales> is | | |
| | | <[34%] | | |
| Identify if the state the | Low | If <State> does not contain any | No | 0 |
| subject property is located | | of the keywords | | |
| in, is a non-disclosure state | High | If <State> contains any of the | Yes | 20 |
| | | keywords | | |

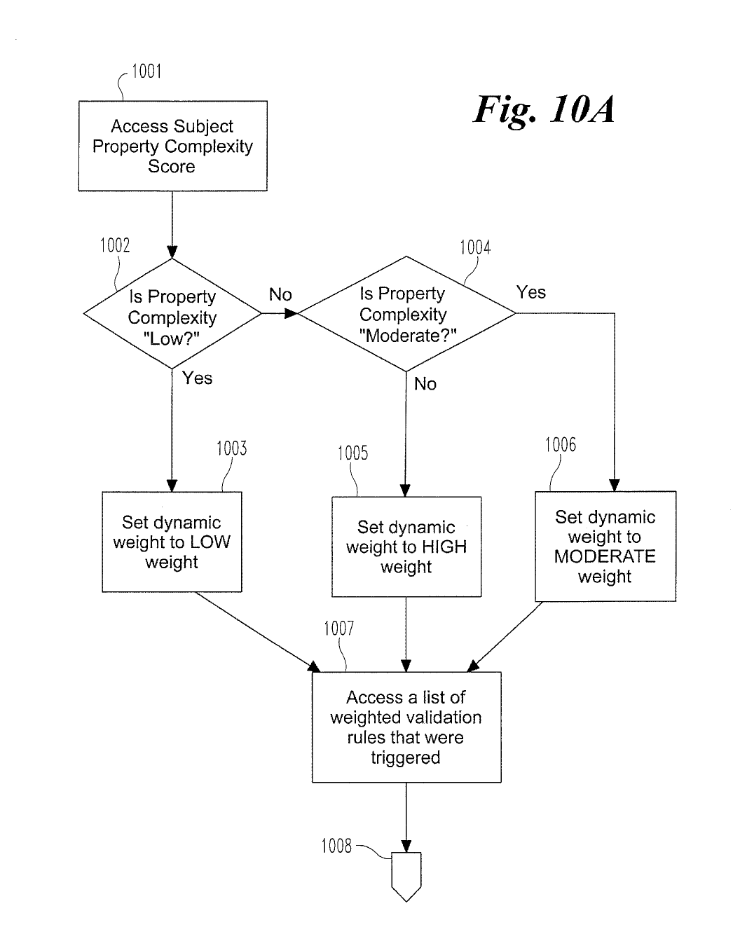

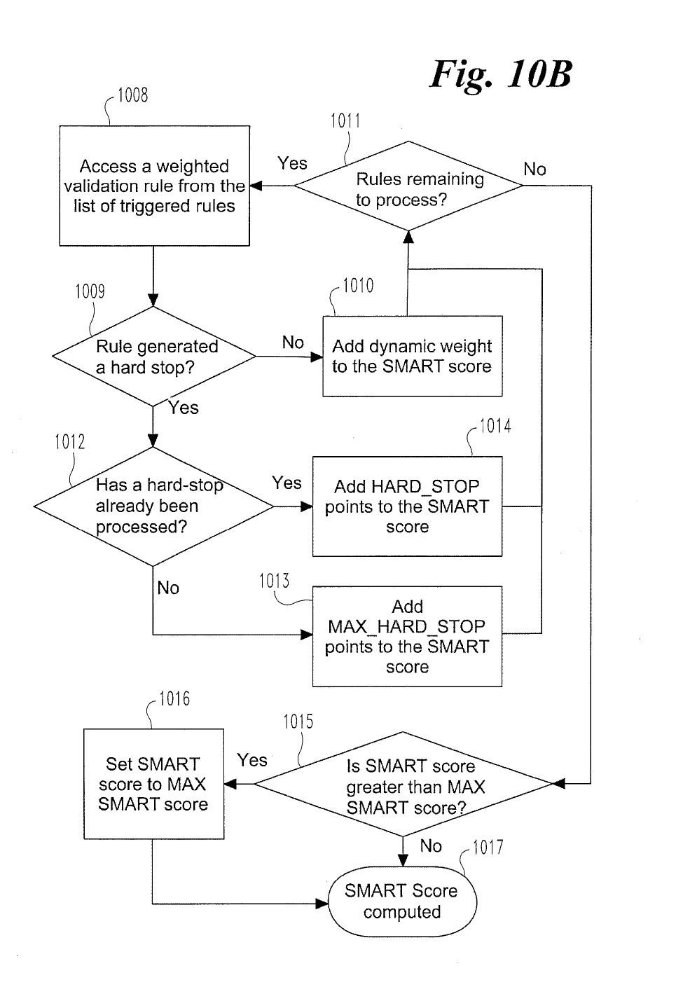

The validation rules are also evaluated (at 802) in a similar manner but yield different types of results. Validation rules seek to verify that the appraisal follows major industry guidelines such as those provided by the Federal National Mortgage Association (FNMA) or “Fannie Mae”, the Federal Housing Administration (FHA), the Federal Home Loan Mortgage Corporation (FHLMC) or “Freddie Mac”, and the Uniform Standards of Professional Appraisal Practice (USPAP). These rules can preferably be configured to include other guidelines as well, or modified as guidelines change. In the preferred embodiment, if the appraisal data along with the information provided from external sources triggers a validation rule, a narrative or explanation is created for inclusion in the final report, and the triggered rule is categorized depending on whether the rule is a weighted rule (803) or an unweighted rule (804). Weighted rules preferably have a score assigned to them that can be aggregated together into a composite score using a dynamic weighting calculation (discussed in greater detail below and shown in FIGS. 10A and 10B) while unweighted rules pass along the narrative for inclusion in a final report without affecting the final score. As indicated in FIG. 8, weighted and unweighted rules can be evaluated simultaneously along with the core rules and subsequent steps begin further processing once all the necessary data is available. However, as noted above with respect to FIG. 7, synchronous operations may be preferable in some situations making it more preferable to, for example, run core rules before validation rules or vice versa depending on the specific implementation of the system.

The results from the core rules, and the list of triggered weighted rules are used in the preferred embodiment as input into the next round of scoring algorithms which includes computing composite or aggregate scores which group together associated collections of validation rule results and core rule scores such as a Subject Property Complexity Score (807), a Statistical Market Analysis Real Time (SMART) Score (810), an Appraiser Credentials Score (808), and a Comparable Date and Opinion of Value Score (809). Aggregating the results into groups of rule scores in this manner rather than using a simple total of all the rule results provides the opportunity to limit the impact of any one group of rules which might otherwise cause a disproportionately large impact on the scores and skew the results. For example, one group or type of rules may include a disproportionately large number of rules capturing perhaps noteworthy details that might be worthwhile to report but might cause an unnecessary or unwanted recurring shift in the final score. By aggregating the rules and the resulting scores into groups, adjustable caps or limits can be applied to account for changes in the configuration, number, and type of rules employed. However, in other embodiments, a simple summation of the rule scores may be more advantageous and this arrangement can also be used.

Examples of the logic used to compile and generate the core rule composite scores is shown below in Table D, where a description of the composite scoring rule, as well as an example of logic that might be used to prepare each composite scoring algorithm for processing, as well as exemplary limits that could be applied after the result is computed. As with previous examples of processing rules and logic, Table D is exemplary rather than exclusive, and indicates the types of logic the system can use to determine the various aggregate scores. The resulting ratings can then be used for various purposes such to facilitate the presentation of various embodiments of graphical rating or ranking indicators within relevant areas of the reports discussed in greater detail below like those discussed above. For example, colors, symbols, words, or any combination, thereof may be used to indicate the risk level to a particular composite result such as “Green” indicators to indicate a low risk, “Yellow” for moderate risk, and “Red” for high risk. The accompanying narrative can then be appended to the report or otherwise used to further communicate the results in the report.

TABLE D
EXAMPLE CORE RULE COMPOSITE SCORE LOGIC

| Rule Description | RulePrep | Logic | Narrative |
|---|---|---|---|
| Assign a risk level of | Total points from Subj | If <SubjPropScore> is | typical |
| high, med, or low to the | Property Complexity | <(30) points, then display | |
| Subject Property | Rules. | the narrative | |
| Complexity section based | *Total points in new node: | If <SubjPropScore> is | moderately complex |
| upon its point total | <SubjPropScore> | >=(30), while <(40) points, | |
| | | then display the narrative | |
| | | If <SubjPropScore> is | highly complex |
| | | >=(40) points, then display | |
| | | the narrative | |
| Assign a risk level of | Total points from | If <ApprCredScore> is | Low |
| high, med, or low to the | Appraiser | <(100) points, then display | |
| Appraiser Credential | CredentialsScore. | the narrative | |
| section based upon its | IF point total is >200, | If <ApprCredScore> is | Medium |
| point total | while <300, | >=(100) points while | |
| | <ApprCredScore> will = | <(300) points, then display | |
| | 200 | the narrative | |
| | IF point total is >300, | If <ApprCredScore> is | High |
| | <ApprCredScore> will = | >=(300) points, then | |
| | 300 | display the narrative | |
| | *Total points in new node: | | |
| | <ApprCredScore> | | |
| Assign a risk level of | Total points from | If <CompDataScore> is | Low |
| high, med, or low to the | Comparable Data Core | <(100) points, then display | |
| Comparable Data or | Rules. | the narrative | |
| Comparable Data and | IF point total is >200, | If <CompDataScore> is | Medium |
| Opinion of Value section | while <300, | >=(100) points while | |
| based upon its point total | <CompDataScore> will = | <(300) points, then display | |
| | 200 | the narrative | |
| | IF point total is >300, | If <CompDataScore> is | High |
| | <CompDataScore> will = | >=(300) points, then | |
| | 300 | display the narrative | |
| | *Total points in new node: | | |
| | <CompDataScore> | | |
| Assign a risk level of | (See FIGS. 10A and 10B) | If <SmartScore> is <(100) | Low |
| high, med, or low to the | | points, then display the | |
| SMART section | | narrative | |
| (Validation rules) based | | If <SmartScore> is | Medium |
| upon its point total, and | | >=(100) while <(200) | |
| the the Subject Property | | points, then display the | |
| Complexity Flag type | | narrative | |
| | | If <SmartScore> is | High |
| | | >=(200) points, then | |
| | | display the narrative | |

The results from these composite or aggregate scoring calculations described in Table D are used in the computation of the final score (811). In one embodiment of the final score calculation, the final score starts at, for example, 1000 and the component scores calculated in steps 807 through 810 are each subtracted. An overall rating such as “low”, “moderate”, or “high” is then assigned and the component scores, and the component scores, final score, and final rating can then be included in the final generated report (812). In one example of the logic used to assign the overall rating, a “low” risk rating is assigned if the final score is greater than a predetermined value such as 800. The overall rating is set to a “moderate” rating if the final score is equal to or less than 800 and greater than a second predetermined threshold value such as 600. Final scores equal to or less than 600 trigger a “high” risk rating. This is but one example as other ranges are also envisioned, as are other types of algorithms for determining the rating.

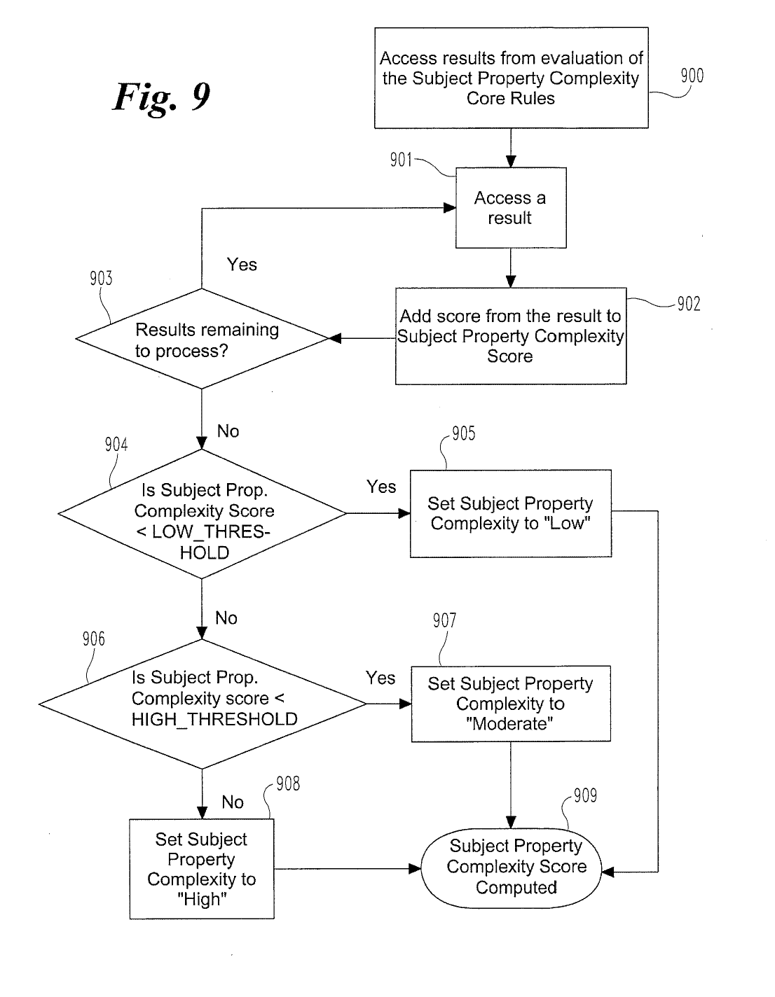

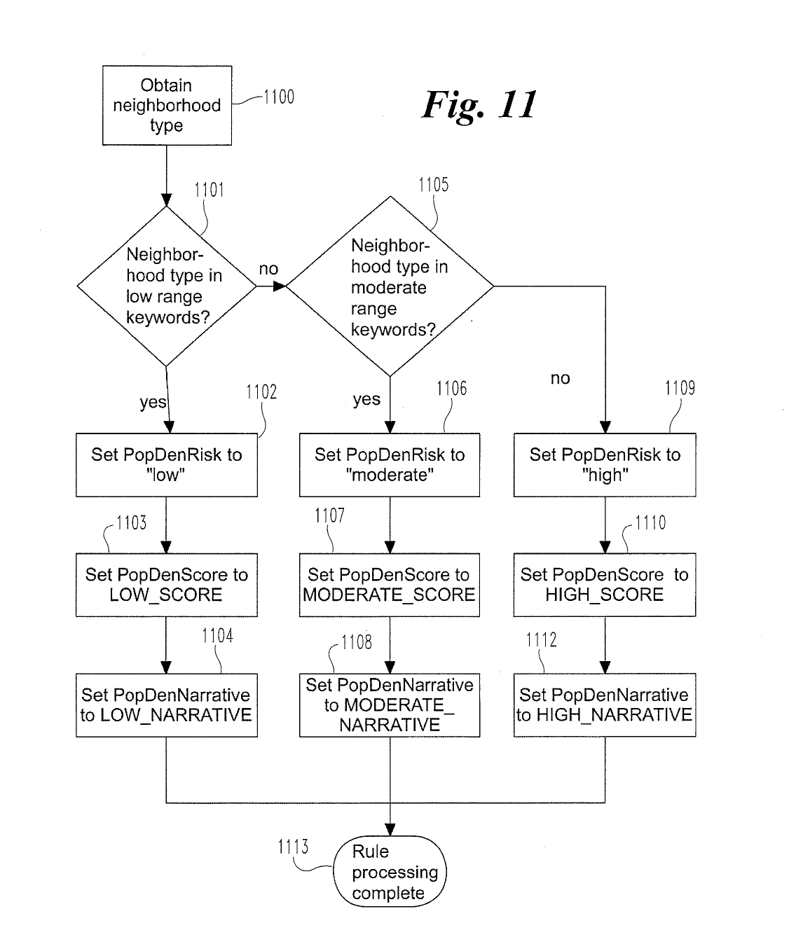

FIG. 9 shows the logical flow of the subject property complexity scoring procedure. The results from the evaluation of the subject property complexity core rules (see FIGS. 11-15 discussed below) are accessed (900) and the individual scores are added together to produce a subject property complexity score by accessing each result (901) and adding the score from the result to the subject property complexity score (902) as long as there are any results remaining to process (903). When no more results remain to process (903), the subject property complexity rating is determined. In one embodiment, the complexity rating is determined by comparing the subject property complexity score to a series of thresholds. In this embodiment, the score is compared to a predetermined value LOW_THRESHOLD (904) such as 30, and if the subject property complexity is less than LOW_THRESHOLD, the subject property complexity rating is set to “low” (905) and the scoring procedure is complete (909). Otherwise, if the subject property complexity score is less than a predetermined HIGH_THRESHOLD (906) such as 40, the subject property complexity is rated as “moderate” (907) and the procedure is complete (909). If the subject property complexity is greater or equal to the HIGH_THRESHOLD, the subject property complexity is set to “high” (908) and the procedure exits (909).

The results accessed in step 900 are generated from the evaluation of core rules (FIG. 8, 805) which include subject property complexity rules. The logical operation of five exemplary subject property complexity rules is shown in FIGS. 11 through 15. As with the list of core rules in Table C above, these are meant merely as examples rather than exclusive list as other methods and techniques for computing a subject property complexity score are also envisioned and may be advantageous as well.

In FIG. 11, a population density rule determines a risk level “PopDenRisk” and assigns a corresponding score “PopDenScore” by comparing the subject property's neighborhood type with a predetermined set of one or more keywords. In one embodiment, the neighborhood type is obtained (1100) from external data sources like external data sources 710 and 800 shown in FIGS. 7 and 8 respectively. If the appraised property's neighborhood type appears in the predetermined “low” set of keywords (1101), the rule sets PopDenRisk to “low” (1102), PopDenScore to a predetermined LOW_SCORE (1103) such as 0, and assigns the narrative PopDenNarrative to a predetermined LOW_NARRATIVE (1104) such as “Urban” completing the process (1113). However, if the neighborhood appears in the “moderate” set of keywords (1105), PopDenRisk is set to “moderate” (1106), PopDenScore is set to a predetermined MODERATE_SCORE (1107) such as 0, and the narrative PopDenNarrative is set to a predetermined MODERATE_NARRATIVE (1108) such as “Suburban” and processing exits (1113). If the neighborhood type is not found in either the low or moderate key words, PopDenRisk is set to “high” (1109), and PopDenScore is set to a predetermined HIGH_SCORE (1110) such as 20, and the narrative PopDenNarrative is set to a predetermined body of text such as “Rural” (1112) and the rule processing is finished (1113).

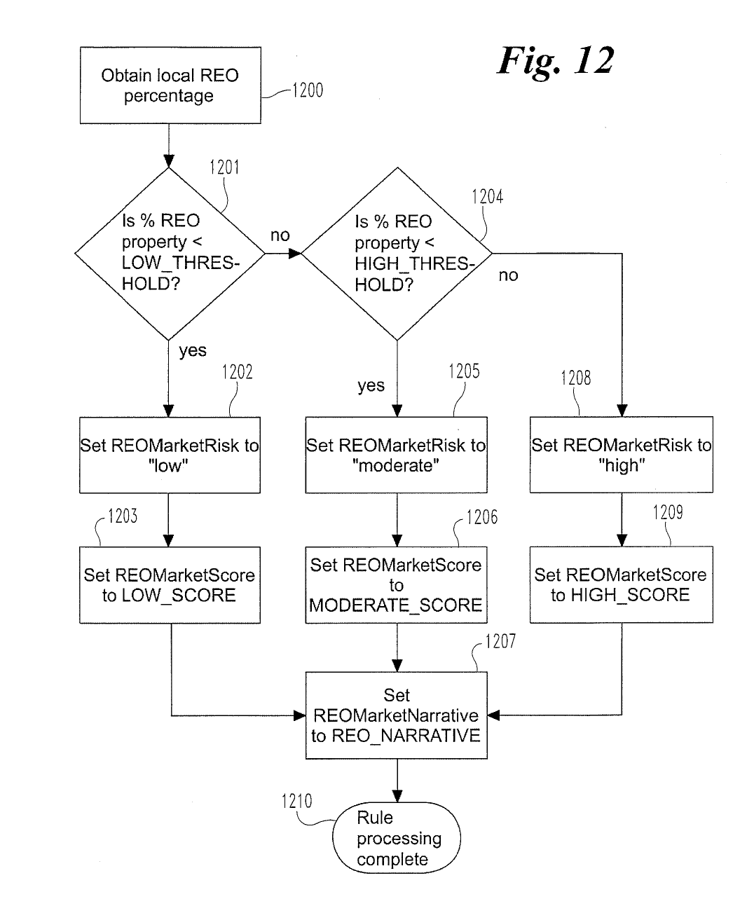

In the second example, the second subject property complexity rule shown in FIG. 12 determines a risk level “REOMarketRisk”, a score “REOMarketScore”, and a narrative “REOMarketNarrative.” In one embodiment of the rule, these determinations are made by comparing the percentage of foreclosed property still owned by a bank or other lender even after an auction near the subject property with a predetermined LOW_THRESHOLD such as 10% and a predetermined HIGH_THRESHOLD such as 20%. Other ranges may be advantageous as well depending on market conditions and the preferred results. In this embodiment, the percentage of real estate property is obtained (1200) and if the percentage of real estate owned property is less than the predetermined LOW_THRESHOLD (1201), REOMarketRisk is set to “low” (1202) and REOMarketScore is set to a predetermined LOW_SCORE (1203) such as 0. If the percentage of real estate owned property is also less than HIGH_THRESHOLD (1204), REOMarketRisk is set to “moderate” (1205) and REOMarketScore is set to a predetermined MODERATE_SCORE (1206) such as 10. Otherwise, REOMarketRisk is set to “high” (1208) and REOMarketScore is set to a predetermined HIGH_SCORE (1209) such as 20. Regardless of the result, in this embodiment of the rule, REOMarketNarrative is set to a value REO_NARRATIVE (1207) indicating the average percentage of real estate owned property for the appraised property's zip code.

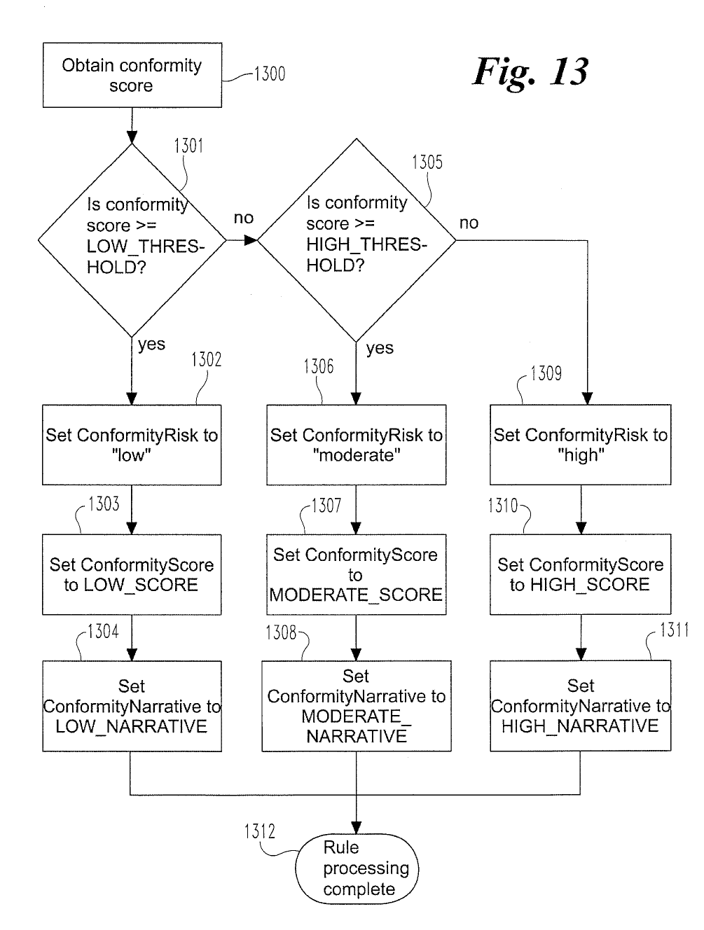

FIG. 13 illustrates the logical flow for one embodiment of a rule that determines a risk level based on the gross living area (GLA) percentage conformity score. The rule first obtains a conformity score (1300) for the subject property. In one embodiment, the conformity score is obtained from an external data source such external data sources 710 and 800 discussed above, however it may also be calculated by the system, received with the appraisal data itself, or provided by some other suitable means. The rule uses the conformity score to determine a risk level “ConformityRisk”, a score “ConformityScore”, and a narrative “ConformityNarrative.” Similar to FIGS. 11 and 12, the embodiment illustrated in FIG. 13 determines if the conformity score is greater than or equal to a predetermined LOW_THRESHOLD (1301) such as 85% and if this is true, it sets ConformityRisk to “low” (1303), sets the ConformityScore to a predetermined LOW_SCORE (1303) such as 0, and assigns a predetermined LOW_NARRATIVE (1304) value such as “Property characteristics are homogenous to its market” to ConformityNarrative and rule processing is complete (1312). If the conformity score is less than the LOW_THRESHOLD but greater than or equal to another predetermined HIGH_THRESHOLD (1305) such as 70%, the ConformityRisk is set “moderate” (1306), ConformityScore is set to a predetermined MODERATE_SCORE (1307) such as 10, and the ConformityNarrative is assigned a predetermined MODERATE_NARRATIVE (1308) such as “Property characteristics are considered somewhat homogenous to its market” and processing is complete (1312). In the case where the conformity score is greater than the HIGH_THRESHOLD (1305), ConformityRisk is set to “high” (1309), ConformityScore is set to a predetermined HIGH_SCORE (1310) such as 20, and the ConformityNarrative is assigned a predetermined HIGH_NARRATIVE (1311) such as “Property characteristics are not homogenous to its market” and the rule exits processing (1312).

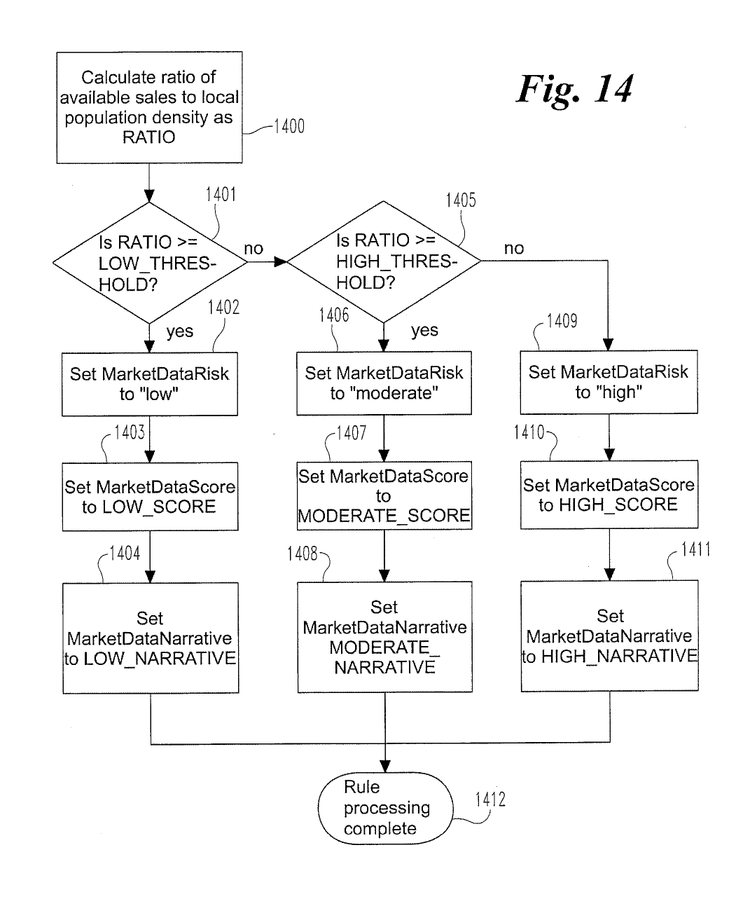

The rule illustrated in FIG. 14 analyzes the current number of properties for sale in comparison to the population density of the surrounding area and assigns a risk level accordingly. In one embodiment of this rule, a ratio of available sales to local population density is first calculated and assigned a value RATIO (1400). One example of a formula for calculating this ratio is as follows:

$$RATIO = \frac{( \begin{matrix}NbhdNumSalesCurrent + NbhdNumSalesPriorQtr + \\ NbhdNumSalesTwoPriorQtr\end{matrix} )}{NbhdNumSimilarSales}$$

Where NhbdNumSalesCurrent represents the current number of properties sold in the subject property neighborhood in the current quarter, NhbdNumSalesPriorQtr represents the number of properties sold in the same region in the prior quarter, NhbdNumSalesTwoPriorQtr represents the number of properties sold in the same region in the quarter before last, and NhbdNumSimilarSales represents the number of similar properties sold in the subject property neighborhood. A risk “MarketDataRisk”, a score “MarketDataScore”, and a narrative “MarketDataNarrative” are assigned values depending the value of RATIO. If RATIO is greater than or equal to a predetermined LOW_THRESHOLD (1401) such as 66%, MarketDataRisk is set to “low” (1402), MarketDataScore is set to a predetermined LOW_SCORE (1403) such as 0, and MarketDataNarrative is given a predetermined value LOW_NARRATIVE (1404) such as “Ratio of available sales to population is acceptable” and rule processing completes (1412). If RATIO is less than LOW_THRESHOLD but is greater than or equal to a predetermined HIGH_THRESHOLD (1405) such as 34%, MarketDataRisk is set to “moderate” (1406), MarketDataScore is set to a predetermined MODERATE_SCORE (1407) such as 10, and MarketDataNarrative is assigned a predetermined MODERATE_NARRATIVE value (1408) such as “Ratio of available sales to population is not optimal” and execution completes (1412). Otherwise (1405), MarketDataRisk is set to “high” (1409), MarketDataScore is set to a predetermined HIGH_SCORE (1410) such as 20, and MarketDataNarrative is assigned a predetermined HIGH_NARRATIVE value (1411) such as “Ratio of available sales to population is unacceptable” and rule processing is complete (1412).

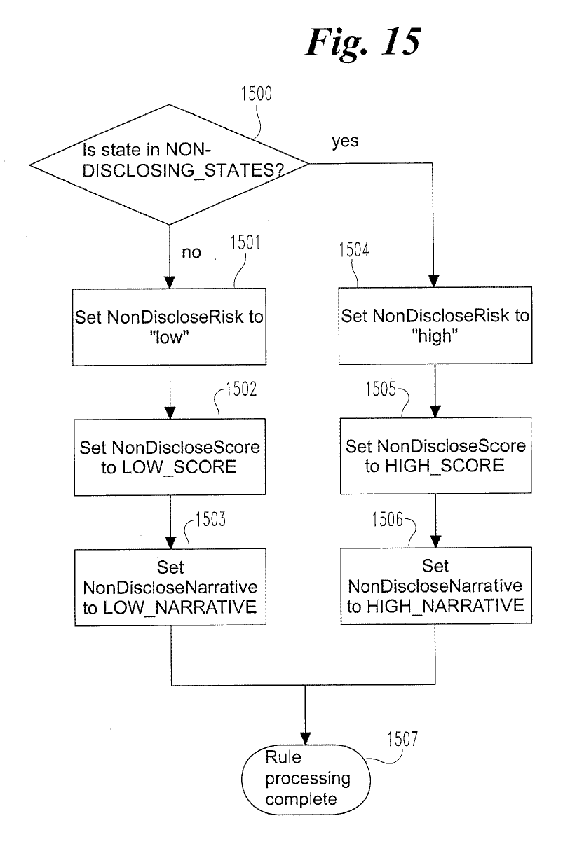

A last example of a subject property complexity rule is illustrated in FIG. 15. In this example, a risk “NonDiscloseRisk”, a score “NonDiscloseScore”, and a narrative “NonDiscloseNarrative” are assigned to the result depending on whether or not the subject property is located in a nondisclosure state (1500). If the subject property state is not found in a predetermined set of NONDISCLOSING_STATES, NonDiscloseRisk is set to “low” (1501), NonDiscloseScore is set to a predetermined LOW_SCORE (1502) such as 0, and NonDiscloseNarrative is assigned a LOW_NARRATIVE value (1503) such as “No”. Otherwise, if the subject property state is a nondisclosing state (1500), NonDiscloseRisk is set to “high” (1504), NonDiscloseScore is set to a predetermined HIGH_SCORE (1505) such as 20, and NonDiscloseNarrative is assigned a predetermined HIGH_NARRATIVE value such as “Yes”.

The subject property complexity computed in FIG. 9 is used both to compute the final score (811), and to compute the SMART score (810). One embodiment of the steps for computing the SMART score is shown in FIGS. 10A and 10B. In this embodiment, a dynamic weight to be applied to each unsatisfied weighted validation rule triggered in step 802 (see FIG. 8) is calculated by accessing the subject property complexity score calculated in FIG. 9. The subject property complexity value is then used to determine the dynamic weight. One embodiment of this process is shown in FIG. 10A. The subject property complexity score is accessed (1001) and the system checks if the subject property complexity was set to “low” (1002) and sets the dynamic weight to a predetermined LOW dynamic weight (1003) such as 30. Similarly, if the subject property complexity is “moderate” (1004), the dynamic weight is set to a predetermined moderate weight (1006) such as 20, otherwise the dynamic weight is set to a predetermined HIGH weight (1005) such as 15. In this embodiment of the rules, the more complex the property appraisal, the less weight is placed on each unsatisfied weighted validation rule.

Once the dynamic weight has been determined, the weighted validation rules that were triggered (i.e. unsatisfied) are accessed (1007) and the rules are then accessed one by one (1008) as shown in FIG. 10B. the rules are evaluated to determine how much each rule should add to the overall SMART score which in this embodiment is initialized at 0. In the embodiment shown in FIG. 10B, a “hard stop” scoring option is also implemented along with the dynamic scoring. If a rule does not generate a hard stop (1009), then the dynamic weight calculated in FIG. 10A is added to the SMART score (1010) and processing continues with the next rule if any rules remain to be processed (1011). If the rule did generate a hard stop (1009), then the system must determine whether any previous rules generated a hard stop (1012). If no hard stops were previously generated, a predetermined MAX_HARD_STOP score such as 200 is added to the SMART score (1013). If a hard stop was previously generated and processed (1012), a predetermined HARD_STOP value such as 50 is added to the SMART score (1014). The collection of triggered weighted validation rules is processed in this fashion until no rules remain (1011). When all rules have been processed, the system may then impose a cap on the SMART score by setting the SMART score equal to a predetermined MAX value (1016) SMART score such as 200 if the SMART score is greater than MAX SMART score (1015). Otherwise execution of the algorithm exits (1017).

FIGS. 3A-3G illustrate pages of an exemplary sample report, each page (i.e., FIGS. 3A-3G) itself being an exemplary embodiment.

FIG. 3A is an example of a report cover page in accordance with an embodiment of the present invention. The present example shows a report with a low appraisal risk, indicated by a green flag. The generated report 155 displays information related to the target property and client. In a glance, a lender is able to see the specific matter information 1, appraisal risk 2, subject property complexity 3, appraiser credentials 4, comparable data 5, and violation of any threshold rules 6. The specific matter information 1 in the header may include the date, file number, client, client reference number, appraisal reference number, appraisal effective date, property address, city/state/zip, borrower, and appraisal value. In this non-limiting example, the appraisal risk 2 is indicated by a colored flag and a numerical score. Under the general scoring methodology, all appraisals start off with a score of 1,000 points and points are subtracted from this total each time a rule is triggered. Results from the rule processing are combined and deducted from 1,000 points with the final result reported as an overall score. Using this score, a recommendation of appraisal risk is determined as low, medium, or high. A short summary below the recommendation elaborates on how that recommendation was reached. Based on that appraisal risk, an action is recommended, such as “low level underwriting,” as in the exemplary embodiment shown.

In this example, the subject property complexity 3 is indicated by a house icon and a colored indicator. The colored indicator may be other shapes or colors, such as green, yellow, red, or blue, depending on the results of the subject market complexity analysis. Accordingly, in the exemplary embodiment shown, the subject market complexity was analyzed by taking into account the flood zone status, population density, REO market, property conformity, and market data availability. Such information may be extracted from external databases. After comparing these data points, the subject property was determined to be noncomplex, as explained in the short paragraph following the initial indication. As such, no flags were raised. In this non-limiting example, the appraiser credentials 4 are indicated by an appraiser icon and a colored indicator. The colored indicator may be other shapes or colors, such as green, yellow, red, or blue, depending on the results of the appraiser credentials analysis. In the embodiment shown, the appraiser's credentials were analyzed by taking into account their license/certification status, state of license, months at license/certification level, license expiration date, distance traveled to subject property, and contract price requirement. After comparing these data points, the appraiser's credentials were deemed satisfactory, and did not raise any flags.

Moreover, in the example provided, comparable data 5 is indicated by a comparable data icon and a colored indicator. The colored indicator may be other shapes or colors, such as green, yellow, red, or blue, depending on the results of the comparable data analysis. In the embodiment shown, the comparable data was analyzed by taking into account factors including, but not limited to, comparable sales price range, sale prices and dates, year built, bed count, gross living area, lot size, sales history and flood zone. After comparing these data points, the subject property did not raise any flags. Finally, the threshold rules 6 are indicated by a rules symbol and a colored indicator. The colored indicator may be other shapes or colors, such as green, yellow, red, or blue, depending on the results of the threshold rules. In the embodiment shown, the threshold rules were analyzed by taking into account guidelines from Fannie Mae, Freddie Mac, the FHA and USPAP standards, and other rules from external databases. After comparing these data points, the subject property raised three flags.

FIG. 3B is an example of a report header in accordance with an embodiment of the present invention. FIG. 3B further specifies the meaning of each element in the report header, such as the 1) date, 2) file number, 3) client, 4) client reference number, 5) appraisal reference number, 6) appraisal effective date, 7) property address, 8) city/state/zip, 9) borrower, and 10) appraisal value. Such information provides the lender a quick reference for necessary information for each matter.

FIG. 3C is an example of an overall report score in accordance with an embodiment of the present invention. FIG. 3C further specifies the meaning of each element in the overall report score, such as 1) the visual indicators for overall risk, 2) appraisal score, 3) overall report score, 4) summary of each scored section, and 5) recommended action. In this non-limiting example, the visual indicators for overall risk are based on appraisal scoring ranges. In the embodiment shown, the range for the Low Risk Appraisal is 900-1000, the range for the Moderate Risk Appraisal is 689-899, and the range for High Risk Appraisal is less than 689. It should be appreciated that this is only one example. Depending on various factors, the ranges could be different. For instance, in another embodiment the range for the Low Risk Appraisal is 800-1000, the range for the Moderate Risk Appraisal is 600-799, and the range for High Risk Appraisal is less than 600. The summary of each scored section provides the lender with a short paragraph on how the appraisal risk was determined. Based on the appraisal risk score, an action, customizable by each client, is accordingly recommended.

FIG. 3D is an example of a subject property complexity in accordance with an embodiment of the present invention. FIG. 3D further specifies the meaning of each element in the subject property complexity section, such as 1) the visual indicator, 2) subject property complexity, 3) flood zone status, 4) population density, 5) REO market report, 6) property conformity, 7) market data availability, and 8) non-disclosure state flag. This section of the report runs the subject property address through numerous data resources. The responses provide the reader of the appraisal report additional market data points that are beyond what is typically found in an appraisal. The results will either indicate that the subject property's characteristics are typical, complex, or very complex in terms of the degree of difficulty in meeting traditional appraisal guidelines. A green check mark may indicate that the results are typical (property and market conditions are not complex). An exclamation mark in a yellow circle may indicate that the results are complex (some property and/or market conditions are complex). An exclamation mark in a red triangle may indicate that the results are very complex (several property and/or market conditions are complex). The subject property complexity, as indicated by flags, displays the total number of warnings. The flood zone data provides either a yes or no response regarding FEMA flood zone status based on flood data services. If yes, additional rules are triggered regarding the flood zone status of comparables used in the appraisal. Population density reports the level of density in terms of low, average, or high. The lower the density, the more difficult comparable selection can become. REO market reports the level of REO activity in the subject's market, allowing the reader of the appraisal to understand the use or non-use of REO comparable sales. Property conformity is based on the subject property's physical characteristics. This provides the level of conformity of the improvements compared to the market surrounding the subject property. Market data availability reports the level of complexity based upon the number of sales over the past 12 months and the ratio of those sales which are comparable to the subject. Non-disclosure state status flags the reader that the subject property is or is not located in a non-disclosure state, which may make it difficult for the appraiser to provide certain information about the comparable sales.

FIG. 3E is an example of an appraiser's credentials in accordance with an embodiment of the present invention. FIG. 3E further specifies the meaning of each element in the appraiser's credentials section, such as 1) the visual indicator, 2) appraiser's credentials flags, 3) license/certification, 4) state of license, 5) months at license, 6) license expiration date, 7) distance traveled to subject property, and 8) contract price requirement. This section of the report compares the appraiser's name and license number against the Appraisal Subcommittee's (ASC) appraiser database to validate the appraiser's credentials. It also provides the reader with the distance that the appraiser traveled to perform the appraisal. Again, indicators are used to quickly show the status of a section. A green check mark indicates that there are no known risks. An exclamation mark in a yellow circle may indicate that the appraiser credentials failed a noncritical rule or are close to failing a client tolerance. An exclamation mark in a red triangle may indicate that the appraiser's credentials have failed a critical rule or are beyond client tolerance. The appraiser credentials, as indicated by flags, displays the total number of warnings. License/certification reports the current status of the appraiser's license as of the date of the appraisal. State of license cross-checks the state of the license provided on the appraisal matches the state that the subject property is located. When available, based on the ASC.gov data, the months at license section will provide how long the appraiser has held their classification. License expiration date provides warnings based on the effective date of the appraisal and the date that the appraiser's license is set to expire. Distance traveled to subject property reports the distance, in both radial and driven miles, from the appraiser's address as noted in the appraisal to the subject property address. Contract price requirement is a configurable flag that will warn when the value of the sales price as noted in the appraisal exceeds the appraiser's current license classification or client preference.

FIG. 3F is an example of comparables in accordance with an embodiment of the present invention. FIG. 3F further specifies the meaning of each element in the comparables section, such as 1) the visual indicator, 2) comparable data flags, 3) appraised value tolerance, 4) comparable sales range, 5) comparable sales prices and dates, 6) comparable year built, 7) comparable bed count, 8) comparable gross living area, 9) comparable lot size, 10) comparable 24 months sales history, and 11) comparable flood zone. This section of the report utilizes Automated Valuation Model (AVM) metrics and public data records and compares them to both the subject property and comparable properties used in the appraisal report. A green check mark may indicate that an acceptable number of rules have passed. An exclamation mark in a yellow circle may indicate that some rules have failed, but not to a critical level. An exclamation mark in a red triangle may indicate that several rules have failed, a hard stop rule has failed, or a single rule beyond client tolerances. The comparable data and opinion of value, as indicated by flags, displays the total number of warnings. AVM vs. appraised value warns the reader when appraised value and client preferences are beyond tolerance. AVM comparable sales price range compares appraised value to the highest and lowest comparables in the AVM results and warns the reader when the appraised value is not within the range. Comparable Sales Prices and Dates validates the Sale Price/Date reported in the appraisal for each comparable against public records, reporting any discrepancies. Comparable Year Built validates the age reported in the appraisal for each comparable against public records, reporting any discrepancies. Comparable Bed Count validates the bedroom count reported in the appraisal for each comparable against public records, reporting any discrepancies. Comparable Gross Living Area validates the gross living area reported in the appraisal for each comparable against public records, reporting any discrepancies. Comparable Lot Size validates the lot size reported in the appraisal for each comparable against public records, reporting any discrepancies. Comparable Sales History is an automated search of 24 months of sales history for each comparable, which warns when sales history has questionable characteristics. Comparable Flood Zone applies if a subject property is identified to be in a FEMA designated flood zone, each comparable is checked for flood zone to make sure any negative influence has been quantified.

FIG. 3G is an example of threshold rules in accordance with an embodiment of the present invention. FIG. 3G further specifies the meaning of each element in the threshold rules section, such as 1) the visual indicator, 2) rules warnings, 3) Fannie Mae guidelines, 4) Freddie Mac guidelines, 5) FHA guidelines, 6) USPAP standards, and 7) SMART rules. This section of the report checks rules based upon Fannie Mae, Freddie Mac, FHA, USPAP and sound appraisal practices. The overall section score is triggered based upon the number of failures or when a hard stop rule has been fired. A green check mark may indicate that an acceptable number of rules have passed. An exclamation mark in a yellow circle may indicate that some rules have failed, but not to a critical level. An exclamation mark in a red triangle may indicate that several rules have failed, a hard stop rule has failed, or a single rule is beyond client tolerance. The rules, as indicated by flags, display the total number of warnings. Fannie Mae Guidelines displays the total number of rules failed related to Fannie Mae requirements. Freddie Mac Guidelines displays the total number of rules failed related to Freddie Mac requirements. FHA Guidelines displays the total number of rules failed related to FHA requirements. USPAP Standards displays the total number of rules failed where USPAP is applicable. Statistical Market Analysis Real Time (S.M.A.R.T.) rules display the total number of rules related to sound appraisal practice requirements. These rules may incorporate numerous standards and guidelines, including, for example, standards and guidelines of governmental agencies.

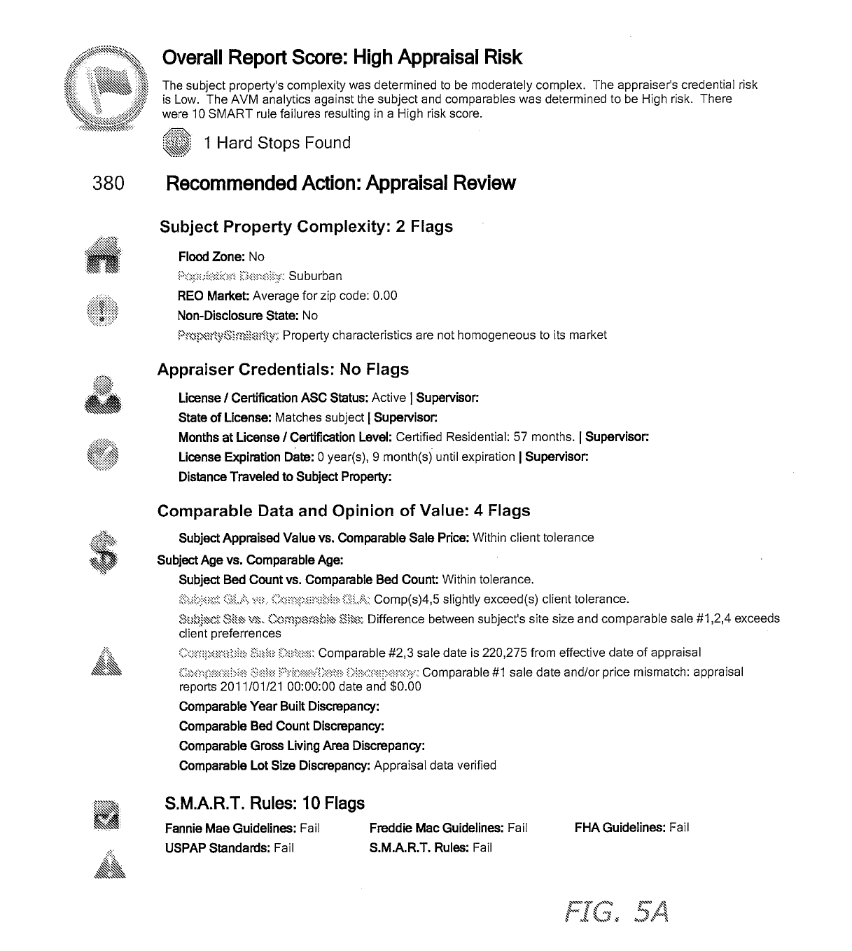

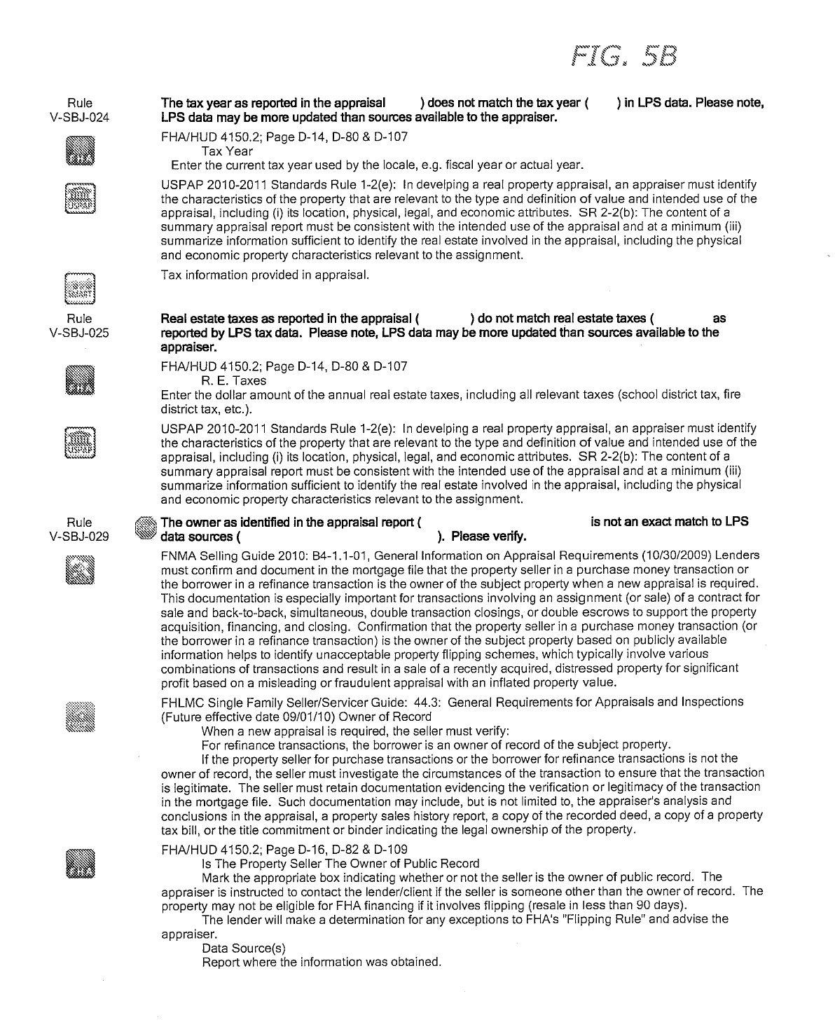

FIG. 5A is an example of a high appraisal risk report cover page. The high appraisal risk is immediately identified by a red flag, a low appraisal report score, and a hard stop sign. The areas needing correction are highlighted, while the areas that are in accordance with the rules are indicated by a green check mark. In this non-limiting example, the property characteristics are not homogenous to the market, the difference between the subject property's site size and comparable sales exceeds client preferences, and all the rules failed. Accordingly, in the exemplary embodiment shown, the report score was a low and resulted in a high appraisal risk, requiring appraisal review.

FIG. 5B is an example of a rules violation report page. The page lists the specific relevant rule and current violation, as well as procedures to correct the violations. If a hard stop is found, that is noted with a red stop sign. In this non-limiting example, the tax year and real estate taxes do not match outside data. Accordingly, in the exemplary embodiment shown, the procedures to correct are noted, along with any hard stops.

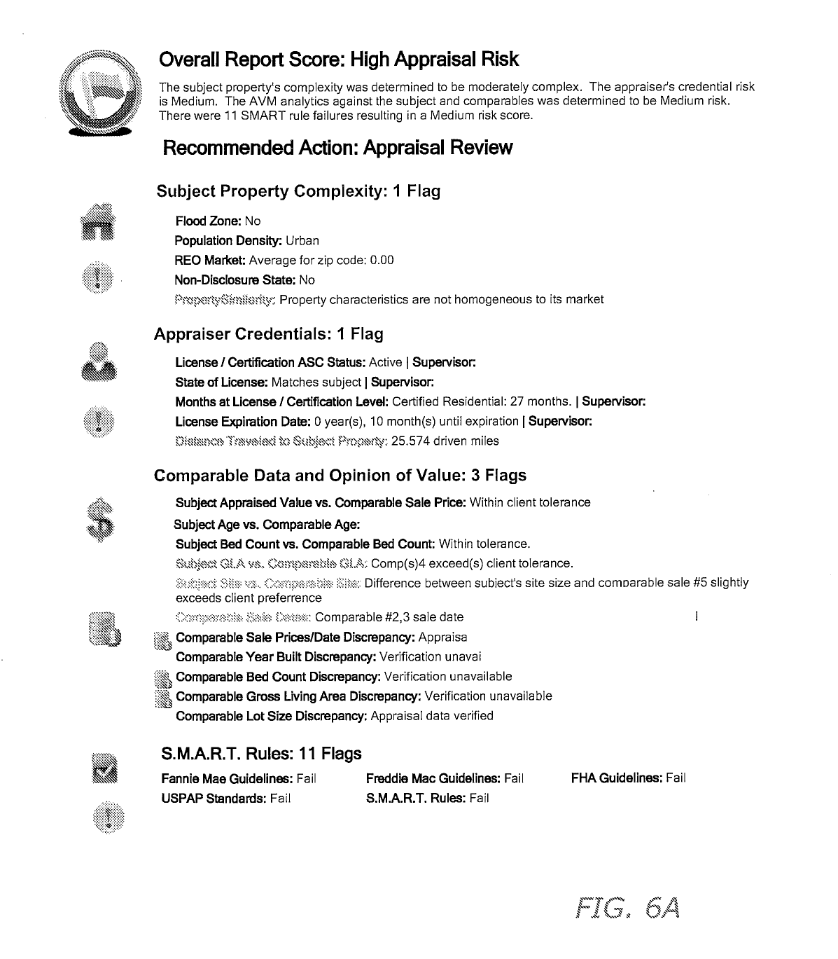

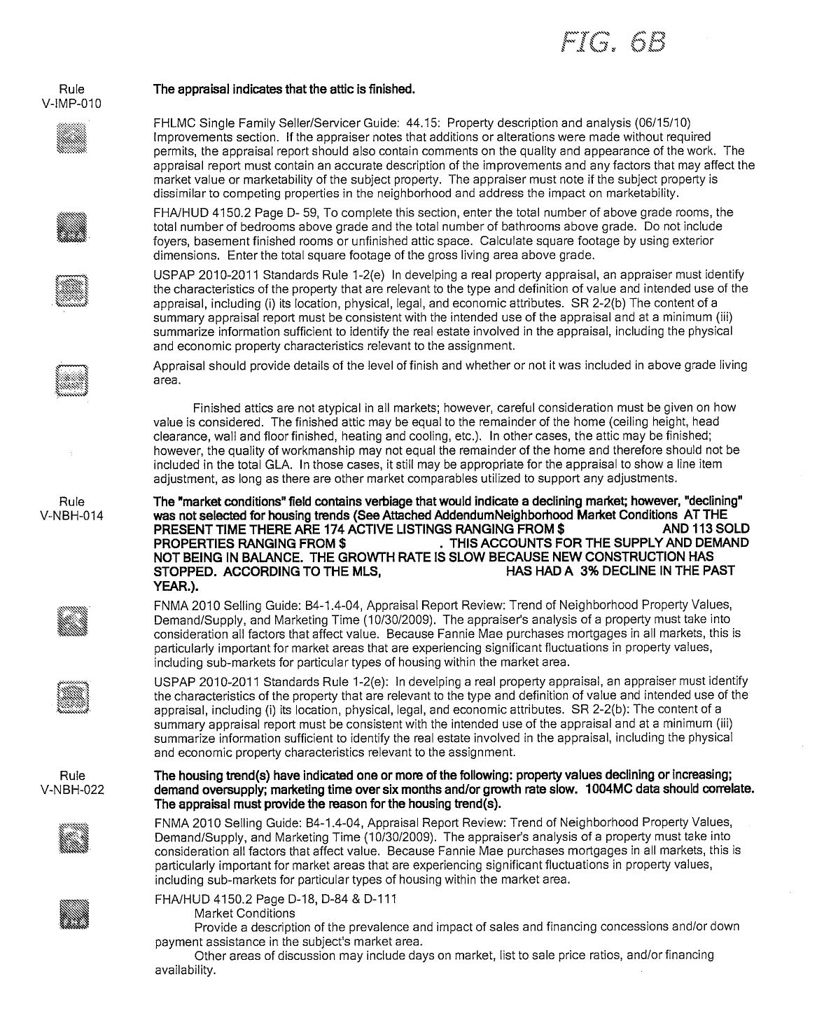

FIG. 6A is an example of a blue high appraisal risk report cover page. The color Blue indicates that outside data providers were unable to complete data verification, so an appraisal review is recommended. For example, in comparable data 5, the last three areas of data could not be verified and are noted as such. In this example, the property characteristics are not homogenous to the market, the difference between the subject property's site size and comparable sales exceeds client preferences, and all the rules failed. Accordingly, the report score was a low and resulted in a high appraisal risk, requiring appraisal review.

FIG. 6B is another example of a rules violation report. This report shows the relevant rules and data that could not be verified by outside data providers. In this example, the appraisal indicates that the attic is finished, resulting in a blue flag. Accordingly, the report required additional data.

The validation report, according to embodiments described herein, supports customization to meet specific client needs. Rules can be turned on or off as part of client configuration. Rules include customizable thresholds and tolerances to match client's underwriting and risk management policies. Clients may have options, outlined in Table 1, for configuration of rules and related features. It should be noted that Table 1 is for illustrative purposes only and is not intended to limit the field names, default tolerances, etc. of the embodiments described herein.

As seen in Table 1, the system may have default configurations relating to the subject property complexity, appraiser credentials, comparable data, and rules. For example, one factor in determining the subject property's complexity is the REO market. REO stands for Real Estate Owned and refers to properties that were foreclosed upon but failed to sell at auction. By default, the REO market field is on (used to calculate complexity), and set with parameters of 1%-10% in the low range, greater than 10% to less than 20% in the medium range, and greater than 20% in the high range. However, a client may define the parameter ranges differently or not use the REO market as a factor in the appraisal report. By default, the subject property complexity is determined by analyzing the flood zone, population density, REO market, whether the property is in a non-disclosure state, and property similarity. Appraisal credentials are verified by determining the appraiser's license status, state of license, months at license/certification level, license expiration date, and distance the appraiser traveled to the subject property. The comparable data is analyzed by looking at data from comparable homes in the area, such as age, bed count, sale dates, and discrepancies, among other data points. The rules in the system may consist of guidelines from Fannie Mae, Freddie Mac, the FHA, and USPAP standards. Any of these parameters may be turned off or edited by the client to suit their preferences.

TABLE 1
Validation Report Configurations

| | | | |
|---|---|---|---|
| Field Name | Field On or Off | Default Tolerances | Client Defined Tolerances |

Subject Property Complexity

| | | |
|---|---|---|
| Flood Zone | On (default) | Low Range: 1-∞ comparables are in |
| | | a flood zone |
| | | Med Range: N/A |
| | | High Range: 0-0 comparables are in |
| | | a flood zone |
| Population Density | On (default) | Low Range Keywords: urban, inner |
| | | city, city neighborhood |
| | | Medium Range Keywords: suburban |
| | | High Range Keywords: small town, |
| | | rural |
| REO Market | On (default) | Low Range: 0%-10% |
| | | Med Range: >10% and <20% High |
| | | Range: >20% |
| Non-Disclosure State | On (default) | Keywords: Alaska, AK, Idaho, ID, |
| | | Indiana, IN, Kansas, KS, Louisiana, |
| | | LA, Maine, ME, Mississippi, MS, |
| | | Missouri, MO, Montana, MT, New |
| | | Mexico, NM, North Dakota, ND, |
| | | Texas, TX, Utah, UT, Wyoming, |
| | | WY |
| Property Similarity | On (default) | Low Range: 85%-100% |
| | | Med Range: 70%-<85% |
| | | High Range: 0%-<70% |

Appraiser Credentials

| | | |
|---|---|---|
| License/Certification | On (default) | |
| ASC Status | | |
| State of License | On (default) | |
| Months at | On (default) | Low Range: 12-∞ |
| License/Certification | | Med Range: 6-<12 |
| Level | | High Range: 0-<6 |
| | | Keywords: AR, GA, HI, KY, MA, |
| | | MI, MN, MO, MS, NC, NH, NJ, OK, |
| | | PA, UT, VA, WA, WI, WV, WY |
| License Expiration | On (default) | |
| Date | | |
| Distance Travelled to | On (default) | If Urban/Suburban: |
| Subject Property | | Low Range: 0-<7.5 |
| (Driven) | | Med Range: 7.5-<15 |
| | | High Range: 15-∞ |
| | | If Rural: |
| | | Low Range: 0-<15 |
| | | Med Range: 15-<30 |
| | | High Range: 30-∞ |

Comparable Data and Opinion of Value

| | | |
|---|---|---|
| AVM vs. Appraised | On (default) | Low Range: 0-10 |
| [symbol] | | Med Range: >10-<20 |
| | | High Range: 20-∞ |
| AVM Comparable | On (default) | |
| Sales Price Range | | |
| Subject Appraised | On (default) | Low Range: 0-<20 |
| Value vs. | | Med Range: 20-<25 |
| Comparable Sale | | High Range: 25-∞ |
| Price | | |
| Subject Age vs. | On (default) | Low Range: 0-<5 |
| Comparable Age | | Med Range: 5-<9 |
| | | High Range: 9-∞ |
| Subject Bed Count | On (default) | Low Range: 0-<2 |
| vs. Comparable Bed | | Med Range: 2-<3 |
| Count | | High Range: 3-∞ |
| Subject GLA vs. | On (default) | Low Range: 0-<12 |
| Comparable GLA | | Med Range: 12-<20 |
| | | High Range: 20-∞ |
| Subject Site vs. | On (default) | Low Range: 0-<98 |
| Comparable Site | | Med Range: 98-<175 |
| | | while NO comp 175-∞ |
| | | High Range: 175-∞ |
| Comparable Sale | On (default) | Low Range: 0-<90 |
| Dates | | Med Range: 90-365 |
| | | High Range: >365-∞ |
| Comparable Sale | On (default) | Low Range: 0-0 comparables |
| Prices and Dates | | Med Range: 1-1 comparables |
| Discrepancy | | High Range: 2-∞ comparables |
| Comparable Year | On (default) | Low Range: All comps 0-<3 yr |
| Built Discrepancy | | difference |
| | | Med Range: Any comp 3-<5 yr |
| | | difference while No comps >=5-∞ |
| | | yr difference |
| | | High Range: Any comp >=5-∞ yr |
| | | difference |
| Comparable Bed | On (default) | Low Range: All comps 0-<1 bed |
| Count Discrepancy | | difference |
| | | Med Range: Any comp >=1-<2 bed |
| | | difference while No comp >=2-∞ |
| | | bed difference |
| | | High Range: Any comp >=2-∞ bed |
| | | difference |
| Comparable Gross | On (default) | Low Range: All comps 0-<5% |
| Living Area | | difference |
| Discrepancy | | Med Range: Any comp >=5%-<10% |
| | | difference while No comp |
| | | >=10%-∞% difference |
| | | High Range: Any comp >=10%-∞% |
| | | difference |
| Comparable Lot Size | On (default) | Low Range: All comps 0-<5% |
| Discrepancy | | difference |
| | | Med Range: Any comp >=5%-<10% |
| | | difference while No comp |
| | | >=10%-∞% difference |
| | | High Range: Any comp >=10%-∞% |
| | | difference |

S.M.A.R.T. ™ Rules

| | |
|---|---|
| Fannie Mae | On (default) |
| Guidelines | |
| Freddie Mac | |
| Guidelines | |
| FHA Guidelines | |
| USPAP Standards | |

[symbol]

indicates data missing or illegible when filed

Turning to implementation specifics, in the illustrative embodiment, the system can operate as software executing on computer 160 (see FIG. 1) which may include one or more processors or CPUs and one or more types of memory. Each memory preferably includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors supplied by INTEL Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Computer 160 represents a “computer” in the generic sense and may be a single, physical, computing device such as a desktop computer, a laptop computer, or composed of multiple devices of the same type such as a group of servers operating as one device in a networked cluster, or a heterogeneous combination of different computing devices also linked together by a network and operating as one computer. Thus computer 160 may be composed of one or more physical computing devices having one or more processors and memory as described above. Computer 160 may also include a virtual computing platform having an unknown or fluctuating number of physical processors and memory devices supporting the operation of the systems described above. Likewise, computer 160 may be located in one geographical location or spread across several widely scattered locations with multiple processors linked together to operate as a single computer connected by a network. Just as the concept of a computer is not limited to a single physical device, so also the concept of a “processor” is not limited to a single physical logic circuit or package of circuits but includes one or more such circuits or circuit packages possibly contained within across multiple computing machines in various physical locations.

The concept of “computer” and “processor” within a computer or computing device also encompasses any such processor or computing device serving to make calculations or comparisons as part of disclosed system. For example, although FIG. 1 appears to show separate computers for processing computer 160, industry standard validation rules 165, and lender customized thresholds 170, in the preferred embodiment of the disclosed system, these rules, thresholds, and processes would operate together as one system, preferably on the same computer, processor, or computing environment. Therefore, processing operations related to thresholds 170, rules 165, and processing computer 160 may occur, for example, on separate servers, the same server with separate processors, or on a virtual computing environment having an unknown number of physical processors as described above.

In one embodiment, computer 160 is coupled to a display and/or includes an integrated display. Likewise, displays may be of the same type, or a heterogeneous combination of different visual devices. Although not shown, each computer may also include one or more operator input devices such as a keyboard or mouse to name just a few representative examples. Also, besides a display, one or more other output devices may be included such as a printer. As such, various display, input and output device arrangements are possible.

The data and operating logic of the system described above can be embodied in signals transmitted over a network, in programming instructions, dedicated hardware, or a combination of these. Thus communications with the system can be achieved by various means such as a wireless or wired Local Area Network (LAN), Municipal Area Network (MAN), Wide Area Network (WAN), such as the Internet, a combination of these, or such other network arrangements as would occur to those skilled in the art. External data sources may also be connected to the system via data access devices connect to these same communications links, or by data access devices may provide data by other means such as via nonvolatile storage devices such as DVD or CD-ROM, flash memory devices, and the like. Users may also interact with the system by submitting appraisals over the same networks or by receiving the resulting reports by nonvolatile copies or by other means. It shall be appreciated that in alternate forms a user submit appraisal information and view reports generated by the system as well as other relevant appraisal information on computing devices such as a PDAs, Blackberries, iPhones, iPads, smart phones or tablet computers, to name just a few illustrative examples.

In one embodiment, users interact with the system via one or more software applications operating on computer 160 which serves HTML pages, sends and receives data via web services, and/or other Internet standard or company proprietary data formats, or maintains dedicated client/server connections in order to facilitate the transfer of information between the user and the system, or between the system and outside datasources. As described above, this interaction can take place over a network such as the internet, a WAN, MAN, LAN, or other suitable electronic communications network. Further, it shall be appreciated that the types of communication methods connected within the above described system need not be of the same type, but that digital, analog, and other technologies may be accommodated simultaneously.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A computer implemented method for evaluating the accuracy of a real estate property appraisal comprising the steps of:
accessing a set of appraisal data using a processor in a computing device, the processor being coupled to a data access device for accessing the appraisal data;
using the processor to compare the appraisal data with one or more validation rules and capturing a resulting set of unsatisfied validation rules;
using the processor to compare the appraisal data with one or more core rules to generate one or more core scores;
generating a property complexity composite score using the processor by comparing the core scores to one or more property complexity composite scoring rules;
generating an appraiser credentials composite score using the processor by comparing the core scores to one or more appraiser credentials composite scoring rules;
generate a comparable data and opinion of value composite score using the processor by comparing the core scores to one or more comparable data and opinion of value composite scoring rules;
using the property complexity score and the unsatisfied validation rules to compute a set of validation rule scores in the processor, wherein the score value of certain unsatisfied validation rules depends on the property complexity composite score;
calculating a validation rules composite score using the processor by comparing the validation rule scores to one or more validation rules composite scoring rules;
calculating a final score, using the processor, by subtracting the property complexity composite score, the appraiser credentials composite score, the comparable data and opinion of value composite score, and the validation rules composite score from a maximum possible score, and;
generating a final report which includes the final score.

2. The method of claim 1 wherein the one or more core rules use external data obtained from one or more external data sources.

3. The method of claim 2 further comprising:
using the processor to compare external data with one or more insufficient data rules to determine a set of available core rules for which there is sufficient external data;
wherein the step of generating the one or more core scores compares the appraisal data to the available core rules without comparing the appraisal data to other core rules.

4. The method of claim 3 further comprising:
using the processor to compare the external data with the one or more insufficient data rules to determine a set of unavailable core rules for which there is insufficient external data, and;
including in the final report one or more unavailable core rule indicators corresponding to the unavailable core rules.

5. The method of claim 1 further comprising:
adjusting one or more of the following scores: the appraiser credentials composite score, the comparable data and opinion of value composite score, the property complexity composite score, the validation rule composite score;
wherein the respective score exceeds a corresponding predetermined maximum score.

6. The method of claim 1 wherein the final report includes rating indicators for the appraiser credentials composite score, the comparable data and opinion of value composite score, the property complexity composite score, the validation rule composite score.

7. The method of claim 6 wherein the rating indicators include color indicia.

8. The method of claim 7 wherein the color indicia are selected from a set of at least four colors.

9. A computer implemented method for evaluating the accuracy of a real estate property appraisal comprising the steps of:
accessing a set of appraisal data using a processor in a computing device, the processor being coupled to a data access device for accessing the appraisal data;
using the processor to compare the appraisal data with one or more validation rules and capturing a resulting set of unsatisfied validation rules;
using the processor to compare the appraisal data with one or more core rules to generate one or more core scores;
generating one or more composite scores using the processor by separating the core scores into one or more groups of core scores and computing a corresponding composite score
using at least one of the composite scores and the unsatisfied validation rules to compute a set of validation rule scores, wherein the score value of certain unsatisfied validation rules depends on the at least one composite score;
calculating a final score, using the processor, by subtracting the composite scores and the validation score from a maximum possible score, and;
generating a final report which includes the final score.

10. The method of claim 9 further comprising:
using the processor to compute one or more risk ratings corresponding to the one or more composite scores;
wherein the final report includes a color risk rating indicator having a color selected from a set of at least four colors.

11. The method of claim 10 further comprising:
using the processor to compare external data with one or more insufficient data rules to determine zero or more unavailable composite scores for which there is sufficient external data to calculate;
wherein the final report includes an insufficient data indicator corresponding to the unavailable composite scores, the insufficient data indicator comprising at least a fourth color.

12. The method of claim 9 further comprising:
using the processor to compare the appraisal data with one or more pre-validation rules to capture zero or more unsatisfied pre-validation rule results,
wherein the steps of comparing the appraisal data with one or more validation rules and comparing the appraisal data with one or more core rules are not executed if the unsatisfied pre-validation rule results do satisfy one or more pre-validation conditions.

13. The method of claim 9 wherein:
the one or more groups of core scores includes a group of subject property complexity scores having a corresponding subject property complexity composite score calculated by the processor;
the one or more groups of core scores includes a group of appraiser credentials scores having a corresponding appraiser credentials composite score calculated by the processor, and;
the one or more groups of core scores includes a group of comparable data and opinion of value scores having a corresponding composite comparable data and opinion of value composite score calculated by the processor.

14. The method of claim 13 wherein the at least one composite score is the subject property complexity composite score.

15. The method of claim 13 further comprising:
using the processor to calculate an overall rating indicator by comparing the final score to one or more overall rating rules;
using the processor to calculate an appraiser credentials indicator by comparing the appraiser credentials composite score to one or more appraiser credentials rating rules;
using the processor to calculate a comparable data and opinion of value rating indicator by comparing the comparable data and opinion of value composite score to one or more comparable data and opinion of value rating rules;
using the processor to calculate a property complexity rating indicator by comparing the property complexity composite score to one or more property complexity rating rules, and;
using the processor to calculate a validation rules rating indicator by comparing the validation rules composite score to one or more validation rules composite rating rules.

16. The method of claim 15 further wherein the final report further includes:
the overall rating indicator;
the appraiser credentials indicator;
the comparable data and opinion of value rating indicator;
the property complexity rating indicator, and;
the validation rules rating indicator.

17. A computer implemented method for evaluating the accuracy of a real estate property appraisal comprising the steps of:
accessing a set of appraisal data using a processor in a computing device, the processor being coupled to a data access device for accessing the appraisal data;
using the processor to compare the appraisal data with one or more validation rules and capturing a resulting set of unsatisfied validation rules.
generating a property complexity composite score using one or more property complexity composite scoring rules, and;
using the property complexity score and the unsatisfied validation rules to compute a set of validation rule scores;
wherein the score value of certain unsatisfied validation rules depends on the property complexity composite score.

18. The method of claim 17 further comprising;
using the processor to compare the appraisal data with one or more core rules to generate one or more core scores;

19. The method of claim 17 further comprising:
generating an appraiser credentials composite score using the processor by comparing the core scores to one or more appraiser credentials composite scoring rules, and;
generating a comparable data and opinion of value composite score using the processor by comparing the core scores to one or more comparable data and opinion of value composite scoring rules.

20. The method of claim 19 further comprising:
calculating a validation rules composite score using the processor by comparing the validation rule scores to one or more validation rules composite scoring rules;
calculating a final score, using the processor, by subtracting the property complexity composite score, the appraiser credentials composite score, the comparable data and opinion of value composite score, and the validation rules composite score from a maximum possible score, and;
generating a final report which includes the final score.

21. The method of claim 20 wherein the validation rules include a subset of unweighted validation rules, wherein if an unweighted validation rule is unsatisfied a corresponding unweighted rule narrative is included on the final report without affecting the final score calculation.
